(19) United States
(12) Patent Application Publication
(10) Pub. No.: US 2024/0411535 A1
(43) Pub. Date: Dec. 12, 2024

(54) SYSTEM AND METHOD FOR TRANSPILATION OF SOURCE CODE USING MACHINE LEARNING

(71) Applicant: HSBC Group Management Services Limited, London (GB)

(72) Inventors: Jude Ken-Kwofie, New York, NY (US); Philip Intallura, London (GB)

(21) Appl. No.: 18/806,406

(22) Filed: Aug. 15, 2024

(51) Int. Cl. G06F 8/51; G06F 8/41

(52) U.S. Cl. CPC G06F 8/51; G06F 8/427

(57) ABSTRACT

The disclosed system and method automate the transpilation of query source code to a distributed data processing system. The process involves instantiating transpiler libraries and source code, executing the source code, and transpiling the source code into a transpiled code using the transpiler libraries. A machine learning algorithm is utilized to control the operation of the transpilation process wherever different transpilation options are available as an automated mechanism for adapting transpilation based on tracked downstream operational characteristics. The system is configured for automatic source code generation in the target language as an output, which can then be deployed to a distributed data processing or query system. Variants are described using a combination of test and production environments for initial testing and tuning of the machine learning model architecture until a performance threshold is met. A same code segment may be transpiled periodically for continual automatic optimization.

### FIELD OF THE DISCLOSURE

The present disclosure relates to automated systems and methods for transpiling query source code and using generative artificial intelligence to computationally optimize the transpilation process for transpiling an initial source code to a target source code.

### BACKGROUND

Transpilation is a process in computer programming where source code written in one programming language is converted into another programming language or target programming language. This process is used to migrate code from one system to another, especially in the context of query languages used for data retrieval in database systems.

Companies facing the challenge of migrating query code from a source system to a target distributed data processing system encounter a multi-faceted problem. Namely, it is difficult to understand the source query code language and the intricacies of the system on which the source query code operates. To facilitate this transpilation of a source code to a target source code, companies may choose one of several paths: develop an in-house transpiler tailored to their specific requirements; adopt an open source transpiler, leveraging the collective efforts of the community; or acquire a commercial off-the-shelf (COTS) translator solution for a ready-made approach.

Regardless of the chosen path, the difficult computing challenge is to efficiently and effectively automate the transformation, reconciliation, and operationalization of the query code. This often demands a substantial investment of company resources, including personnel, time, and budget. The process of building, testing, operationalizing, and monitoring an in-house, open-source, or COTS query code transpiler to a distributed data or query processing system is typically labor-intensive and complex, often costing immense time, money, and labor. These and other deficiencies exist. Thus, there currently exists a need for a new system of transpiling source code into a target source code that addresses these deficiencies.

### SUMMARY

In some aspects, the techniques described herein relate to a system for automated transpilation of query source code to a distributed data processing system, including: a processor; and a memory in communication with the processor and storing instructions that, when executed by the processor, cause the processor to perform operations including: downloading from a library database a transpiler library and source code; executing the source code; transpiling the source code into a transpiled code using the transpiler libraries; analyzing, via a machine learning algorithm, the transpilation process for accuracy; and generating recommendations for optimization of the transpilation process.

In some aspects, the techniques described herein relate to a method for transpiling query source code to a distributed data processing system, including: downloading, by a processor from a library database, a transpiler library and source code; executing, by the processor, the source code; transpiling, by the processor, the source code into a transpiled code using the transpiler libraries; analyzing, by the processor via a machine learning algorithm, the transpilation process for accuracy; and generating, by the processor, recommendations for optimization of the transpilation process.

In some aspects, the techniques described herein relate to a non-transitory computer-readable medium in communication with at least one processor and storing instructions that, when executed by the at least one processor, cause the at least one processor to perform operations including: downloading from a library database a transpiler library and source code; executing the source code; transpiling the source code into a transpiled code using the transpiler libraries; analyzing, via a machine learning algorithm, the transpilation of the source code into the transpiled code for accuracy; and generating recommendations for optimization of the transpilation of the source code into the transpiled code.

A computer implemented system is provided for automated transpilation of query source code by transforming an initial source code provided in an initial programmatic language into an output source code provided in a target programmatic language. The system includes a computer processor operating in conjunction with a non-transitory computer readable medium storing computer interpretable instruction sets, the computer processor configured to first decompose the initial source code to generate a syntax tree (AST) data structure, the AST data structure representing programmatic constructs within the initial source code as nodes of a plurality of nodes of the AST data structure. A trained machine learning data model architecture is maintained on the system and coupled to a transpiler library, trained for controlling transpilation between the initial programmatic language and the target programmatic language by identifying equivalent code pairs as indicated in the transpiler library. The AST data structure is processed using the trained machine learning data model architecture to automatically identify equivalent code for transpilation of each node of the AST data structure between the initial programmatic language and the target programmatic language in the transpiler library for generation of the output source code in the target programmatic language.

Upon identifying a plurality of available transpilation options in the transpiler library during the identification of equivalent code, the trained machine learning data model is configured to generate output logits corresponding to each available transpilation option, the available transpilation option of the with a highest output logit being selected as the equivalent code for generation of the output source code in the target programmatic language.

The output source code in the target programmatic language is coupled with telemetry metadata representative of the plurality of available transpilation options and the selected available transpilation option used for the selection of the equivalent code; and wherein the trained machine learning data model architecture is retrained using a combination of performance data and the telemetry metadata representative of the plurality of available transpilation options.

The performance data includes data sets extracted from daemon processes monitoring at least one of, or a combination of, processing errors, processing speed, storage requirements, memory usage, and computing processing cycle usage associated with downstream execution of the output source code.

The combination of the telemetry data and the processing monitoring data are used for causing the trained machine learning data model architecture to be trained in accordance with a real-time feedback loop.

During a pre-training duration after instantiation of an untrained machine learning data model architecture, the downstream execution is conducted on a non-production environment simulating real-world usage and the untrained machine learning data model architecture is first trained during execution in the non-production environment to establish the trained machine learning data model architecture for usage in a production environment. This allows the training to occur on mock data, and initial errors can be rectified automatically through the use of tracked telemetry and metadata.

The computer implemented system, in some embodiments, can be a special purpose computing machine operating in a data center coupled to a message bus having an application programming interface for receiving data sets representative of the initial source code and for providing the output source code as output data sets.

### BRIEF DESCRIPTION OF THE DRAWINGS

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 is a block diagram illustrating a system according to example embodiments.

FIG. 2 is a flow diagram illustrating a method of generating one or more recommendations for improving the transpiled code, according to example embodiments.

FIG. 3 is a flow diagram illustrating a method of generating and integrating recommendations to improve the transpiled code and the transpilation process, according to example embodiments.

FIG. 4 is a flow diagram illustrating a method of generating and monitoring a machine learning model, according to example embodiments.

FIG. 5 is a flow diagram illustrating a method of generating recommendations, receiving feedback from users, and applying the feedback to the transpiled code and transpilation process, according to example embodiments.

FIG. 6 is a block diagram illustrating a system according to example embodiments.

FIG. 7 is a pictogram of an example AST being transformed into equivalent code as part of the transpilation, according to some embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

One or more embodiments disclosed herein relate to an automated system that updates and translates database search code from a first programming language to a second programming language. This process streamlines the integration of an in-house, open-source, or COTS query source code transpiler into existing engineering processes. Such a system provides a structured approach to converting, building, testing, reconciling, deploying, and reporting of query code into a target distributed data processing system, thereby optimizing resource utilization and enhancing overall efficiency of the transpilation process.

The system downloads the relevant transpiler libraries and the source code. The system then proceeds to execute and transpile the source code into the target code using these libraries. The libraries assist with the transpilation process by providing computer executable code which can be invoked by the system during the transpilation process for automatic conversion, and in some embodiments, optimization or rectification during the generation of the target code.

It is important to note that there are many different approaches for code conversion during transpilation, and the system may be configured for selecting an optimal approach for code conversion. The libraries assist with the transpilation process by providing configurable functionality for this conversion, for example, providing mechanisms for replacing specific syntax with eligible options in the target language.

As different languages have different strengths and weaknesses, for example, due to the architectural design of the language (e.g., some languages are optimized for ease of execution efficiency), and have different balances of available features, options, and capabilities, there is an opportunity during the transpilation process to improve the overall operation and functionality of the code translation process. For example, a particular type of memory allocation or approach for memory management may help increase the efficiency of the execution of the code, and this approach may become available during the language translation process. Conversely, certain languages have increased computational costs as it relates to execution of certain types of function, and those less efficient functions should be avoided where possible.

Finally, the transpilation process can also inadvertently introduce errors (especially around edge case scenarios) into the generated replacement transpilation code, so in some embodiments, a feedback approach is proposed herein to track performance efficiency and/or errors over time using a machine learning model and to aid the decision making for the transpilation process.

For example, errors over time can be measured in terms of service tickets, and performance efficiency can be measured using daemon processes that are configured to track execution times of equivalent processes for baseline analysis. These execution/error characteristics can be encoded as vectors, and corresponding transpilation code transformation decisions can be stored as input/output pairs.

A machine learning algorithm is generated and tasked with analyzing the transpilation process, for example, trained using the input/output pairs tracked from previous transpilation activities, and used during inference to improve the transpilation process through biasing the machine learning approach to select transpilation decisions that reward desired output characteristics, which, for example, could include an objective function that could be a weighted function balancing improved performance and a reduction in execution errors. The machine learning algorithm, in this case, could be a trained neural network having parametric model weights that are refined during a training process (or in some embodiments, reinforcement learning approaches can also be used for a model that is being trained continuously as transpilations occur in real time).

This algorithm analyzes the transpiled code to identify patterns, inefficiencies, and potential areas for optimization, and as noted, the analysis can include tracking, for a period of time, or continuously after the transpilation, estimated errors or performance impacts of the transpiled code. Based on this analysis, the machine learning module can be used during inference to generates one or more logical outputs (e.g., logits) that can be used for automated transpilation decision making, representing improved recommendations for optimizing the transpiled code. The recommendations can be provided in the form of machine instructions, such as machine instructions to replace/rewrite a particular function using a specific code type available in the target language. Where there are multiple options, for example, the code can be used to select the code that has a highest output score associated with the target objective function.

These recommendations aim to improve the performance and efficiency of the code within the distributed data processing environment. The machine learning algorithm learns from each transpilation attempt, and it uses feedback from the execution of the transpiled code (that can be monitored over time) to refine its analysis and improve future recommendations. The feedback can be used to generate a feedback loop whereby a transpilation machine learning engine maintains an updated representation that is periodically re-trained using tracked performance and error output data to refine weights stored therein, for example, representing a trained latent space.

This feedback loop allows the system to adapt and enhance its optimization mechanism over time, leading to more efficient transpilation processes and better-performing code in the target distributed data processing system. Essentially, the machine learning system is adapted to automatically encourage optimization during the transpilation process balanced against error propagation. Where there are multiple options for transpilation, the machine learning system tracks telemetry information for downstream observation by a feedback data process configured to obtain telemetry information associated with a particular transpilation option between two languages. For example, there may be multiple ways of programming a type of repetitive loop (e.g., for loop, do while, go-to statements) or memory space allocation, and where the ML system is able to select from multiple options, these decision points can be tracked using labelled metadata coupled to the transpilation. During a re-training process, the labelled metadata can be coupled with telemetry information for feedback and re-training, biasing the system to automatically optimize decision bifurcation between the decision points. For example, a particular conversion may run faster, but may also yield a greater likelihood of execution errors.

Systems and methods of the present disclosure provide numerous advantages. The system addresses the technical problem of transpiling, or translating, query source code from one data processing system to another, which is a common challenge during system upgrades or migrations. Traditional methods of transpilation are often manual, error-prone, and resource-intensive. They require specialized knowledge of both the source and target query languages, as well as a deep understanding of the underlying systems. This process can be slow and costly, with a high risk of introducing errors that can lead to data retrieval issues and system malfunctions.

The improved transpilation process described herein instead utilizes computational learning through iteratively refined representations of a trained machine learning model to bias automatic transpilation decisions towards variations that yield improved computational performance. Variations of different approaches are proposed herein.

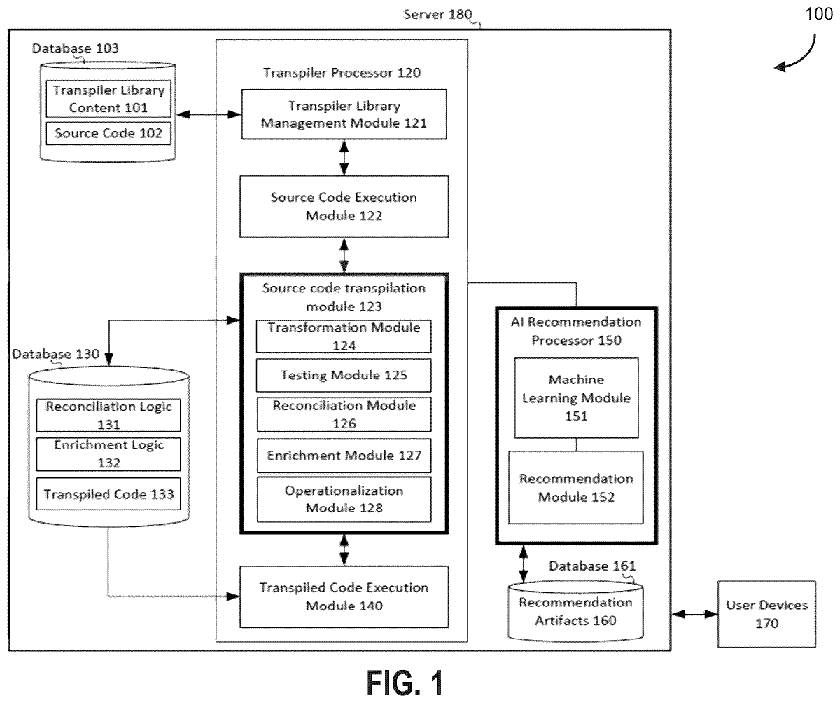

FIG. 1 is a block diagram illustrating a system 100, according to example embodiments. The system 100 may include a server 180 which itself may include a transpiler processor 120 and an artificial intelligence (AI) recommendation processor 150 (having a machine learning module 151 and a recommendation module 152). The transpiler processor 120 includes several modules including a transpiler library management module 121, source code execution module 122, a source code transpilation module 123, and a transpiled code execution module 140. The source code transpilation module 123 itself includes a transformation module 124, testing module 125, reconciliation module 126, enrichment module 127, operationalization module 128. These modules are implemented in the form of computing process functions that can, for example, be physically implemented in the form of libraries of computing functions that can be executed by a processor or a set of computing processors.

The transformation module 124, based on the semantic analysis of a source query abstract syntax tree (AST), is a software component that adds target processing system query language equivalent built-in or custom transformation functions to the target query code. The source query is first converted (as described below using a data structure transformation) into a tree-like structure representing its core elements (functions, variables, etc.) This simplifies analysis which gathers meaning and structure of the source query using an AST. As an example, each AST could include tree objects representing each block or section of code, and have node objects representing functions or variables, sub-functions, essentially the elements that make up a software code. For loops, if statements, the constructs would be broken down into a tree like structure. Tree objects may also reference other trees, for example, if there are nested statements, or interconnected code sections. Each node can have properties associated with that node, and interconnections can be represented in the form of properties between individual nodes.

Accordingly, a large program can be decomposed into a “forest” of AST trees, from a computational perspective, and it is this set of ASTs that is provided alongside the code during the transpilation process. The base structure of the AST can then be provided to a parallel ML engine as described herein for automated decision making in relation to performance, accuracy, and/or readability improvements as described in various sections herein.

Built-in transformation functions convert data from one format, standard, or structure to another. Transformation functions are named, specified in the language of the target query system and applied during the transpilation build. Based on the source query's needs, the module injects transformation specific functions into the target query code. The target query code will have its own functions for transformation based on the structure of the source code. If the source code has a function to upper case a word, the system can uncover an equivalent code that the target system has to uppercase characters. If there is no specific function existing on the target side, instead, a combination of functions can be used to equate a similar function. Where there are a number of potential combinations of functions or different equivalent code functions that can be swapped in during the transpilation process, the system may be configured to run the trained machine learning model in inference mode to generate logit outputs indicating a potential best option based on the optimization of a particular loss function based on a balance of target objectives.

As described in some embodiments herein, telemetry information can also be incorporated at this step as an additional input during the transpilation process to aid the trained machine learning model to generate more accurate code decision outputs.

These functions can be:

Built-in: Provided by the target processing system querying language itself. These functions typically handle common data format conversions (e.g., changing dates between formats).

Custom: Defined specifically for the source query's needs. These might handle complex data manipulations not covered by built ins.

The target processing system querying language refers to the language understood by the target system the query will be used on (e.g., PySpark). Each transformation function has a unique name within the target language and system. This unique names are used as a reference to help track the history of quality and performance over time, for example, providing reference points for the training of the machine learning model. When input ASTs (and their corresponding telemetry data) are used for training, the machine learning model uses the transformation functions or representations thereof as part of the latent space, and builds updated parametric relationships based on the training. Over enough training epochs, the system builds a strong representation of performance enhancement decisions that can be automatically applied. The transpilation build refers to the process of transforming the source query code into the target system's code with the injected functions.

### Example

Source Query: Consists of a query to uppercase the first and last name of customers who live in Hawaii.
Transformation Module:

Analyzes the AST of the source query, identifying the computational elements of “uppercase,” “customer,” and “Hawaii.” These computational elements are used to generate the structural components of the AST, such as nodes, edges, and connections.

Injects equivalent transformation functions into the target query code; e.g., PySpark:

UPPER function (built in) to change all the characters of the first name and last name to uppercase.

Target PySpark (after transformation):

results=spark.load (‘customers_table’).withColumn (‘uppercased_first_name’,
built functions_upper (‘customer_first_name’)).withColumn (‘uppercased_last_name’,
built_functions . . . upper (‘customer_last_name’))

The testing module 125 is a software component responsible for checking if the transformed code (from source query to target system query language) functions as expected when supplied mock data. Acting like a transpiled quality check, the testing module ensures the transformed code functions correctly using mock data before it interacts with real data in the target system. This helps prevent errors and unexpected behavior when the transformed code is used for its actual purpose.

The testing module uses a set of pre-defined functions to perform the checks. These functions cover various scenarios to ensure the transpiled code handles different cases correctly. Mock data is used instead of using real data from the target system, the tests rely on pre-defined mock data that simulates real-world data. This simplifies testing and avoids making changes to the actual target query system.

The tests themselves are stored in a database with names for identification. The database holds configurations for the tests as well as specifying which mock data to use and the expected results. The testing module runs the tests on the transpiled code before it is used on real data via the reconciliation module. This helps catch errors early in the process and prevents issues when interacting with the target system.

Results are logged. The outcome of each test (pass/fail) is recorded in the system for future reference. This allows the machine learning module to track the history of the tests and identify any regressions (cases that used to pass but now fail).

For example, following the application of the transformation module which consisted of a query to uppercase the first and last name of customers who live in Hawaii.

Test Configuration: A pre-defined test function exists that checks if the transpiled code injected with the transformation functions correctly uppercases all the characters in the first and last name of customers living in Hawaii. The test configuration in the system database specifies: the transpiled query code to test, and mock data containing customer information, including a flag for “Hawaii” location.

Expected result: The first and last name uppercased where they are from “Hawaii”.

Test Execution: Before using the transformed code on real data, the testing module runs the test. It feeds the mock data into the transformed SQL code and compares the output with the expected result (total count of California customers).

Outcome: There are two possibilities:

Pass: If the transpiled code correctly provides the expected result using the mock data, then the test passes. This indicates a high likelihood that the code will work correctly with real data. This is logged and monitored by the machine learning module.

Fail: If the transformed code does not correctly produce the expected result or encounters errors with the mock data, then the test fails. This is logged and monitored by the machine learning module. Failures alert the machine learning module and organization engineers of potential issues with the transpiled code that needs to be fixed before using it on real data.

This approach helps ensure the transformed code is functional before interacting with real data. It catches errors early on, preventing issues and saving time by avoiding issues with the target system.

The enrichment module 127 is a software component that injects additional information or context to the transpiled query code to make its output more meaningful. For an example, a query observing customer information can be enriched with data from another source or table, which provides more context for that particular information or record. These enrichment requirements can be established through a set of pre-defined enrichment actions (e.g., all legacy phone numbers having seven digits are to be enriched to be include area codes and country code calling numbers). These can be used to improve or enhance a target query.

The enrichment module relies on a set of pre-defined functions where these functions determine how the data will be enriched. During the transpilation testing stage, the enrichment module uses pre-defined mock data to illustrate how enrichment would work with real data. This allows for a preliminary enrichment step using mock data to understand how the final results might look. During the transpilation reconciliation process, the enrichment module uses real contextual data to provide the most relevant information.

The enrichment functions themselves are stored in a database with names for reference. The database holds configurations for these functions as well as specifying the type of contextual data to use and how to integrate it with the query results. Enrichment adds value to the output of the target query to gain deeper understanding of the data, identify trends or patterns that might not be evident from unenriched data alone, and make better-informed decisions based on the enriched data.

For example, a pre-defined enrichment function exists to enhance the transpiled code data output. The transpiled code data output requires location data to be merged to the data output consisting of the uppercased first and last name of customers living in Hawaii.

The enrichment function is configured to:
Update the transpiled query code with the necessary syntax needed to:
   Access the customer location database,
   Look up customer locations in the location data where the customer and customer location identifiers are equal,
   Retrieve the customer street address, city, state, and zip code, and
   Merge the customer location.

The reconciliation module 126 is a software component responsible for ensuring the transpiled query code (converted from source query to target system language) produces accurate results and is performant based on performance benchmarks using real data from the target system.

Reconciliation relies on a set of pre-defined functions that compare the output of the transpiled code with the expected results. Reconciliation acts as a final validation step and uses real data to ensure the transformed code produces the correct output before it is relied upon for critical tasks. By using real data, the reconciliation module provides a high level of confidence in the transpiled code's functionality before it's used for critical tasks. This helps prevent errors and ensures the data retrieved by the transformed code is accurate and reliable.

Reconciliation uses real data retrieved from the target system itself to validate the code's functionality in a real-world scenario. The reconciliation module runs its checks before the transpiled code is used for its intended purpose (operationalization). This helps identify issues before they can impact actual data or downstream processes. The reconciliation functions themselves are stored in a database with names for easy reference. The database holds configurations for these functions as well as specifying how to compare results and acceptable thresholds for deviations between expected and actual values.

The outcome of the reconciliation process (success or fail) is recorded in the system for future reference. This allows both the machine learning module monitoring function and organization engineers to track the history of the reconciliation and identify any regressions (cases that used to pass but now fail).

For example, a pre-defined reconciliation function exists that checks if the transpiled code injected with the transformation and enrichment functions correctly uppercases all the characters in the first and last name of all customers living in Hawaii enriched with customer locations and using real customer data. The reconciliation configuration in the system database specifies:
The transpiled query code to reconcile.
Real data containing customer information, including the “Hawaii” location.
Expected result: The first and last name uppercased where they are from “Hawaii”

This reconciliation function is configured to:
Access the customer and location data from the actual system data,
Look up customer locations in the location data where the customer and customer location identifiers are equal,
Retrieve the customer street address, city, state, and zip code, and
Merge the customer location.
The transpiled code retrieves data from the target system. The reconciliation module then:
   Compares the overall count of records obtained by the transpiled code with the count it generated.
   Compares the case and values of the first and last names obtained by the transpiled code with the reconciliation function.
   Compares the case and values of the first and last names obtained by the transpiled code with the reconciliation function.
   Checks if the deviation between counts falls within an acceptable threshold (defined in the system database).
   Checks if the deviation between first and last name values falls within an acceptable threshold (defined in the system database).
1. There are two possibilities:
   Pass: If the counts match or the deviation falls within the acceptable threshold, the reconciliation process passes. This indicates the transformed code is likely working correctly with real data. This is logged and monitored by the machine learning module.
   Fail: If there's a significant difference between the counts, the reconciliation process fails. This is logged and monitored by the machine learning module. Failures alert the machine learning module and organization engineers of potential issues with the transpiled code that needs to be fixed before using it on real data and purposes.

The operationalization module 127 is a software component responsible for integrating the transpiled and validated query code into the everyday operations (workflows or tasks) of the target distributed data and query system. The operationalization module bridges the gap between transpilation and deployment. It takes the final, validated code and puts it to work within the larger system, ensuring it delivers data as intended.

The transpiled and validated query code refers to the code generated after it has been translated from the source query language and successfully passed the testing and reconciliation stages. The operationalization module takes the final code and embeds it into the relevant processes or systems where it will be used to retrieve data on a regular basis. This, in some embodiments, involves scheduling the code to run automatically at specific times or integrating it with other applications that rely on the data it generates.

The operationalization module has functionalities to monitor the performance of the integrated code. It tracks how long the code takes to run, resource usage, or error logs. These are feature engineering inputs that are encapsulated as a data object for input as tuples. Statistics of errors are provided into the machine learning model for a particular identifier of a query or a transformation thereof. Those can be associated with errors and metrics, and those can be provided into the machine learning model. These errors can occur due to potential edge cases where the transpilation process can introduce errors. Where a large number of errors are identified, the system can either bias away from that particular transformation function, or, in some cases, flag the transformation function for human review before re-inserting it as a viable path for transpilation. Accordingly in some embodiments, the machine learning model may be used during inference to generate error scores for each transformation function to identify poorly performing transformations for refactoring.

This information is crucial for identifying and resolving any issues that arise after the code is deployed and to support the retraining of the machine learning model. In case of errors or performance problems, the operationalization module might trigger alerts to notify developers or system administrators. This allows for prompt intervention and troubleshooting to ensure the smooth operation of the integrated code. This is important for the automation process as transforming code at scale using automated mechanisms can lead to aberrations due to tracked errors that may be indicative, not of issues with the code transformation itself, but perhaps relating to a human developer's error introduced during the writing of a transformation script, which can be remediated by a refactoring. For example, there may be dependencies that are simply not available, stored in a different area, have changed API syntaxes, that may not be properly updated.

The AI recommendation processor 150 can include a machine learning module 151 and a recommendation module 152. These modules may be collections of code or instructions stored on a media that represent a series of machine instructions that implement one or more actions explained below. Each of these modules can be stored within a memory or data storage unit associated with the server 180. The server 180 may also include a number of databases including database 103, database 130, and database 161. Database 103 may include one or more transpiler library content 101 and one or more source code 102. The database 130 may include reconciliation logic 131, enrichment logic 132, and transpiled code 133. The database 161 may include one or more recommendation artifacts 160 generated by the recommendation module 152. The system 100 may also include one or more user devices 170 which can communicate with the server 180 over one or more wired or wireless networks.

Transpiler library content 101 can be stored in the database 103. The transpiler library content 101 can include one or several transpiler libraries. A transpiler library is a collection of software components that provide the functionality to convert source code written in one programming language into another programming language. Each transpiler library can include without limitation core code, supporting dependencies, configuration files, documentation, and APIs. The transpilation approach may also include target global objectives where there is a push towards reducing a total number of dependencies or libraries being called, and the machine learning model may be trained or tuned with this objective. For example, overall performance metrics can be utilized during the training process to optimize (e.g., minimize) a total number of libraries that ultimately will be dependencies for the project.

The process of converting source queries to target code (transpilation) can be automated. This automation, is governed by the operationalization module 128, leverages the target query processing system's CI/CD (Continuous Integration and Continuous Delivery) pipeline, and in-house developed, open-source project(s), or COTS transpiler code. Transpiler libraries typically includes main library with core code and supporting dependencies. The configuration steps are as follows:
1. Download transpiler libraries in company software management system. Transpiler libraries can be provided from in-house, open-source project(s), or COTS. Libraries typically include executables and supporting configurations. The system during its initial installation prompts for:
   a. Specify transpiler library location.
   b. Software management system web URL (internal/external)
   c. Company file storage
   d. Select library version.
   e. Pick Target OS
   f. Perform download.
   g. Complete configuration
2. Installation of query code transpiler libraries
   a. Install per target computing environment requirements.
3. To enable automation, several configurations are required:
   a. CI/CD System: The continuous integration and deployment (CI/CD) system itself needs to be configured to handle the workflow. The system is set to use the organization's existing CICD sub-system.
   b. Repositories: Specify the locations of the source and target query code repositories.
   c. Modules: Define the transformation, enrichment, test, and reconciliation module records to be used in the pipeline. These modules were explained in previous discussions.
   d. Scheduling: Using the organization's CICD subsystem, set up a schedule to trigger the automation process at specific times.
   e. Notification: Using the organization's event bus subsystem, publish automation workflow notification events.
   f. Logging: Push telemetry events to the logging subsystem.
4. Workflow Execution:
   a. Once configured, the system runs automatically based on the defined schedule and module settings.
5. Workflow Stages:
   a. Trigger: The scheduler starts the process.
   b. Target Code Generation: The CI/CD pipeline retrieves the source query code and executes the transpilation process with the transformation, enrichment, test, and reconciliation modules to generate the equivalent target system query code.
   c. Artifact Storage: The generated target code, if deemed of good quality, is stored as an artifact (a file or object representing the code's output) in the target query code repository.
   d. Deployment: Finally, the target code, if deemed of good quality, tis deployed as a library within the target distributed query system. This means the code is made available for use by other applications or processes that need to interact with the target system.

Overall, this approach automates the entire process of transforming and deploying source queries. It leverages CI/CD to ensure efficient and reliable code generation and deployment.

Core code may contain the logic for parsing the input source code, understanding its syntax and semantics, and then generating the corresponding code in the target language. Supporting dependencies may include additional modules or packages that the core code relies on to perform its tasks.

Dependencies may include libraries for parsing (e.g., lexer and parser libraries), code generation, error handling, and other utilities that assist in the transpilation process. Configuration files may contain settings that customize the behavior of the transpiler, such as specifying which language features to support or how to handle specific translation scenarios.

Documentation can include documents that explains how to use the library, including how to integrate it into a development environment, how to configure it, and how to troubleshoot common issues. APIs (Application Programming Interfaces) are sets of protocols and tools for building software and applications.

Furthermore, a transpiler library may offer an API that allows other software to interact with it programmatically, enabling automation and integration with other tools, such as IDEs (Integrated Development Environments) or build systems. The transpiler library content 112 may be developed in-house, sourced from open-source projects, or acquired as commercial off-the-shelf (COTS) solutions. However, it is important to note that despite how the transpiler library is obtained, during the transpilation process itself, there are different options for how a same original code can be translated into the target code, and as described herein, this provides an opportunity for automated optimization during the transpilation process.

The libraries may be used to transpile source code from a format used in a legacy or current system to a format compatible with a distributed data processing system, enabling the integration of disparate systems and the leveraging of modern computing environments. While manual transpilation is possible, it is not practical for large volumes of transpilation, and further, manual transpilation may not yield an optimal amount of efficiency gains or optimizations during the transpilation process, as it can be difficult to track performance over time. However, as described herein, an improved transpilation engine and corresponding methods are proposed to provide machine learning based improvements to the transpilation process so that optimizations may automatically conducted during an opportunity to leverage modern computing and corresponding modern coding languages, for example. In another variation, the transpilation process can include a combination of human in the loop and computer optimization, whereby, for example, normalized logit outputs of the machine learning model can be ingested for rendering into a decision support interface where a developer or human in the loop user can quickly select between options for transpilation.

A benefit of using machine learning to aid in the transpilation process is that combined with a feedback loop, optimizations become possible without explicit knowledge of the benefits and drawbacks of different code languages and execution of code thereof, but instead, the system can automatically tune towards improved outcomes over time. This is particularly beneficial for transpilation at scale between a many to many relationship between different source and target coding languages.

From a feedback loop perspective, a number of different embodiments are possible. For example, every 30 days, a new snapshot of telemetry information can be obtained and used for re-training, and different versions of the machine learning engine can be sequentially generated, tested, and put into production. In another variation, the transpilation machine learning engine can be re-trained in real-time. A challenge with real-time feedback training is that there is a potential for the system to become un-operational due to aberrations or spurious relationships that are introduced into machine learning engine's latent space.

There can be different versions of the machine learning model that are available in parallel. The transpilation engine, in some embodiments, may be able to swap between different versions or use multiple versions at once to generate different target outputs, which can be evaluated over time with tracked telemetry to identify which machine learning model version works best.

Similarly, unlike human transpilation, a machine learning approach does not need to distinguish between procedural programming languages, functional programming languages, object oriented languages, scripting languages, additional features in certain languages such as automatic memory allocation/garbage cleanup, etc., allowing the system to automatically tune towards the strengths of the target language. Syntactical differences and improvements are also possible, such as changing data object types (e.g., linked list representations as opposed to arrays, integers, floats, short integers, long integers, binary large objects).

The transpiler library management module 121 can retrieve transpiler library content 101 from the database 103 over a wired or wireless network. Next, the transpiler library management module 121 may retrieve and/or receive the source code 102 from the database 103. The source code 102 can include any programming language or set of programming instructions.

Next, the source code execution module 122 executes the source code 102. The source code execution module 122 may execute the source code 102 by a parser or some other suitable means. For example, the parser may check the syntax of the code to ensure it follows the rules of the source language and breaks it down into a data structure known as an abstract syntax trec (AST), which represents the hierarchical syntactic structure of the code. In some example embodiments, the source code execution module 122 may engage in semantic analysis. For instance, a source query code of ‘select upper (name) from customers’ can be represented in an abstract syntax tree (AST). Effective query transformation requires a deep understanding of the source code's structure and semantics. Abstract Syntax Trees (ASTs) support analyzing and manipulating code during the transpilation process. An AST is a tree-like data structure that captures the essential syntactic elements and organization of the query code. It focuses on the hierarchical relationships between code components, offering a clear representation of the code's structure.

The construction of an AST involves breaking down the query code into its fundamental building blocks, known as tokens. These tokens can include keywords (e.g., SELECT, FROM), identifiers (e.g., name, customers), functions (e.g., UPPER), operators (=), and literals (e.g., strings, numbers). The individual tokens are then arranged into a hierarchical structure using nodes and edges:
Nodes: Represent the different components of the code, such as keywords, function calls, expressions, and statements.
Edges: Connect the nodes, indicating the relationships between them. The root node sits at the top, representing the entire query. Child nodes branch out from the root, representing sub-elements of the query.

ASTs provide a representation of the code's structure, making it easier to understand complex queries, especially for those with extensive logic or nested operations. With the code in a structured format, ASTs enable deeper analysis of its functionality. This allows for transformations that go beyond simple text manipulation, such as identifying and optimizing redundant operations or restructuring the code for improved performance. The core structure captured in an AST is not specific to a particular programming language. This allows the same AST representation to be used for both the source and target query code, simplifying the transformation process.

The information encoded within the AST facilitates semantic analysis. This stage delves deeper into the meaning of the code represented by the AST. Semantic analysis can identify potential issues that might not be evident from the structure alone, such as:
Syntax Errors: Inconsistencies in the code's grammar or usage of keywords can be flagged during this stage.
Type Mismatches: Semantic analysis can ensure that data types are used appropriately within the query.
Performance Bottlenecks: By identifying redundant or inefficient operations within the AST, semantic analysis can inform optimizations that improve the target query's performance.

For example, once the code is parsed into an AST, the source code execution module 122 may perform one or more semantic analyses to understand the meaning of the code. This may involve checking for semantic errors, resolving variable and function names, and ensuring that operations are valid according to the language's rules.

Next, the source code transpilation module 123 may begin transpilation of the actual code. The source code transpilation module 123 can include several other modules including a transformation module 124, a testing module 125, a reconciliation module 126, an enrichment module 127, and an operationalization module 128. The transformation module 124 may perform a transformation according to the rules that define how constructs in the source language map to constructs in the target language. This is where the actual transpilation occurs, as the source code's structure and logic are systematically converted into the equivalent structures and logic of the target code. The transformation module 124 may also generate the transpiled code 133 from the source code 102 and output the code in the syntax of the target language.

The source code transpilation module 123 can transpile or attempt to transpile the source code 102 into the target code one or more times. In some cases, the source code 102 may not perfectly transpile into the target code on the first attempt. For example, a given transpilation attempt may include syntax errors, semantic discrepancies, mismatches in language between the source code 102 and the transpiled code 133, performance issues, data model incompatibilities, or other problems.

The initial attempt at translating a source query to target code (transpilation) might not meet performance or data quality requirements. With reconciliation and performance optimization process, the system performs reconciliation, comparing the transformed code's output with real data from the target system. If performance is poor (e.g., slow processing due to large data volume), the system checks the reconciliation table. This table stores performance metrics and configured compute resource settings. If the initial attempt exceeds the set performance thresholds, the system consults the monitoring function of the generative artificial intelligence module.

Transpilation machine learning engines may be tuned for particular pairs of translations. For example, a specific transpilation machine learning engine may be retrained and tuned based on performance information as between the specific particular pairs of translations.

The analyzer function analyzes how other queries have performed on the same target system. Based on this analysis, the generative AI module recommendation engine 150 recommends adjustments to compute resources (e.g., memory or CPU) for the retry. The transpiled code is then automatically retried with the recommended compute resource settings. From an implementation perspective, the analyzer function is provided through processing incoming strings through a trained machine learning model data architecture (e.g., trained parametric representation trained iteratively to adjust automated decision making between different transpilation options). The corresponding output can be a computerized estimation of the correct decision making to optimize a particular outcome. For example, the transpiled code may be directed to operate on a system with limited storage space, and thus optimization may be for performance despite limited storage. A specific data type or data structure may be better suited for limited storage (at the cost of processing speed), and the system may be configured to bias the transpilation decision automatically for operation on this specific target system as the system may receive as an input signal the type of system and/or its limitations as part of the processing inputs.

In terms of data quality and syntax issues, reconciliation module also attempts an optimization process. If the reconciled data quality falls short of expectations, a similar process occurs. The generative AI module analyzes the query code and recommends modifications to the target query code's syntax. The query code is then automatically retried with the syntax adjustments suggested by generative AI.

Only after successfully passing both the testing and reconciliation stages can the transformed code be operationalized (put into service). If the transpiled code fails to meet performance or data quality targets after retries, it's persisted in the database for further investigation. Moreover, the organization's engineering team is notified of the failed translation via the event bus. This likely means an engineer needs to intervene and manually review or adjust the transformation process.

Overall, this system automates retries and optimizations for query transformations. It leverages AI-powered monitoring, analysis, and recommendations, generative AI module, to suggest adjustments for performance and data quality issues. This approach can significantly improve the efficiency and effectiveness of the overall transformation process.

For example, the system attempts to transform a source query code that retrieves customer data stored on the target distributed query system.

The system translates the source query and generates the target query code. During reconciliation, the system finds that the transformed code takes an excessively long time to run due to the massive amount of customer data. The reconciliation time set in the reconciliation table surpasses the performance benchmark set in the system. The reconciliation module triggers the generative AI module, in particular the monitoring subsystem.

The generative AI analyzer sub-module examines the historical performance data of similar queries on the distributed query system. Based on its analysis, generative AI recommender sub-module recommends increasing the memory allocated to the transformed code during execution. This recommendation is automatically updated in the reconciliation table. The system automatically retries the transformed code with the increased memory allocation. The retry with the additional memory proves successful. The transformed code retrieves the data efficiently, meeting the performance benchmarks. Since the transformed code has passed both testing and reconciliation stages, it can now be deployed and used for regular data retrieval from the cloud data warehouse.

Another example, the initial reconciliation reveals data quality issues. For instance, the retrieved customer data might be missing some values or contain inconsistencies. Additional examples include NULL values where there should not be NULL values, wrong formatting of currency, or wrong formatting of date and time. There can be a profiling step that is conducted to check the quality of the output data (e.g., row counts, syntax checking, data validation). The profiling may generate different error thresholds (e.g., if this error rate exceeds a particular value), as a proxy of the materiality of a data quality issue. From a telemetry perspective for machine learning, the data quality issues can be read from an event bus, or a notification can be sent to an event bus and can be used to generate notifications for human review. A data object can be generated that can be used to communicate a quality vs. performance of the transpilation process, and this can be shared on the event bus and consumed by downstream processes, such as a re-training of the machine learning model. An organization can tune the machine learning model to identify the types of errors that are critical (e.g., replacing key values with NULL) and which are benign (e.g., rounding errors on floating point calculations).

The reconciliation process detects discrepancies between the expected and retrieved data. Similar to the performance issue, the system consults the generative AI module for analysis and recommendations. The generative AI analyzer analyzes the data quality discrepancies and the structure of the transformed code. The generative AI analyzer may recommend a minor modification to the target query code's WHERE clause to filter out irrelevant data or address potential errors in data retrieval logic. The transpiled code is automatically retried with the adjusted syntax. The retry with the modified syntax retrieves clean, high-quality data, meeting the data quality benchmarks.

The automation of transpilation with retry and generative AI module assistance can improve the efficiency of the query transformation process. The automation process helps identify and address performance and data quality issues without requiring manual intervention for every case. This allows engineers to focus on more complex tasks while the system handles routine optimizations.

To address these issues, the testing module 125 may conduct one or more predetermined tests on the transpiled code 133 and the transpilation process, including syntax verification, semantic verification, regression testing, load testing, and stress testing. Syntax verification may include checking the transpiled code 133 for syntax errors and may further include generating an error message with a description of the syntax error. Regression testing may include testing the transpiled code 133 to ensure that the transpiled code 133 still operates correctly after modifications or other changes are made to the transpiled code 133. Load testing may include testing the system under the expected workload. Stress testing may include testing the system under extreme workloads to identify its breaking point or any bottlenecks in the transpilation process. Semantic verification may include checking the semantics of the transpiled code to ensure it maintains the same meaning and functionality as the original source code. Any semantic discrepancies detected may be flagged for correction. Stress testing in the transpilation process is important, especially when dealing with large workloads in production environments. The stress testing helps ensure the transpilation process is robust and efficient. It allows for identifying and addressing potential performance bottlenecks or semantic quality issues before real-world deployment, minimizing the risk of disruption to critical production workloads.

For example, the transpilation process converts source query code into target query code suitable for a distributed query system (often used for handling massive datasets). A distributed query system can include complex architectures where the target query may impact worker nodes, etc. for supporting high scale/high volume batch process (e.g., clearing house activities). These target systems are usually mission-critical, supporting numerous other production workloads that read and write large volumes of data. Introducing a new process like transpilation can potentially impact the performance and stability of the existing production environment. Stress testing helps identify potential bottlenecks or issues before deploying the transpilation process in production. The stress testing approach is as follows:
The system is tested in a non-production environment to avoid impacting real workloads.
This environment simulates the extreme workloads typically encountered in production.
The transpilation process is then scheduled to run against a large collection of source query code, mimicking real-world usage.
The stress test is run multiple times, gradually increasing the amount of source code processed.
This helps assess how the transpilation system scales with increasing workload. Two key aspects are evaluated during the stress test:
   Performance: This involves monitoring compute metrics like CPU usage, memory consumption, and processing time associated with the transpilation process. The goal is to ensure the process doesn't negatively impact the overall performance of the system.
   Semantic Quality: This refers to the accuracy and correctness of the transpiled code. The test aims to identify any issues with the transformed code's ability to produce the expected results.

Once the testing module 125 has tested the transpiled code 133 and the transpilation process for errors and inefficiencies, the reconciliation module 126 may generate one or more reconciliation logic 131 during the transpilation process. The reconciliation logic 131 may include a set of rules used during the transpilation process to ensure that the transpiled code 133 accurately reflects the intent and functionality of the original source code 102. Key aspects of evaluating the quality of the transformed code (target query code) generated during the transpilation process are intent and functionality. Regarding intent, this module is configured with a focus on ensuring the target code is human-friendly and adheres to coding standards. For instance, the code should be written in a clear and concise style, using proper indentation, naming conventions, and comments. This makes it easier for engineers and other users to understand the code's purpose and logic. The code must adhere to the syntax rules of the target query system's language. Any syntax errors would prevent the code from running correctly. Consistent formatting improves readability and maintainability of the code. This might involve checking for proper indentation, spacing, and use of parentheses, and automatic insertion or correction based on readability improvements as part of the transpilation process. For example, the transformation functions may also include, as part of the automatic transpilation process, that also updates for visual stylistic amendments automatically. The transpilation process may include the insertion of a transpilation signature for the target code that could be used for future telemetry (e.g., the name, the target of the transpilation, a date of transpilation, a machine learning model version, and, in some embodiments, an identifier based on a specific machine learning decision that was made by the machine learning model).

Regarding functionality, this module verifies if the transformed code can produce the intended results on the target system. The transpiled code is executed on the target system using real data that would typically be used in production (test and reconciliation modules). The output generated by the transpiled code is compared against a pre-defined “reconciliation data output.” This reconciliation data represents the correct output expected for the given input data. By comparing the transpiled code's output with the reconciliation data, the system can determine if the code is functionally correct and produces the desired results.

For example, when transforming a query that calculates the average customer's amount per product category, the system's generative AI analyzer analyzes the generated target code (transpiled code) and analyzes for clear variable names, proper indentation, and comments explaining the code's logic. The code adheres to the target system's query language dialect (e.g., using the correct syntax for averaging and grouping data). The analyzer ensures the target code has consistent indentation and spacing for easier understanding.

Moreover, with the reconciliation module the transpiled code is executed on the target system using real data. The system uses a pre-defined dataset containing the expected customers for each product category (reconciliation data output). The reconciliation module compares the results generated by the transpiled code with the reconciliation data. If the transpiled code's output matches the reconciliation data perfectly, it passes the functionality evaluation. This indicates the code is functionally correct and produces the desired results. If there are discrepancies between the outputs, the code fails the functionality evaluation. This might point to errors in the transformation process that need to be investigated via the generative AI module.

With intention issues, if the code fails the intent evaluation due to readability issues, the system might automatically reformat it or suggest improvements to variable names and comments. For syntax errors, the system flags the specific lines with potential issues, allowing engineers to review and correct them. Engineers are notified via the notification event bus.

Each piece of reconciliation logic 131 is associated with metadata, such as an identifier (_id), a version number (_version), a name, the reconciliation code itself, and a reconciliation type. The reconciliation module 126 may generate the reconciliation logic 131 by comparing the outputs of the transpiled code 133 against the source code 102 results to identify any discrepancies or errors that may have been introduced during the transpilation process. In some embodiments, the reconciliation module 126 may compare the transpiled code 133 generated by the transformation module 124 with the source code 102 and subsequently generate reconciliation logic 131 based on this comparison. Once the reconciliation module 126 generates the reconciliation logic 131, the reconciliation module 126 may store the reconciliation logic 131 in database 130. Furthermore, the reconciliation module 126 may inject the reconciliation logic 131 into the transpiled code 133 to correct any errors in the transpiled code 133.

Similarly, the enrichment module 127 may generate enrichment logic 132 based on any errors and inefficiencies found by the testing module 125 during the transpilation process, e.g. when the testing module 125 find inefficiencies in the transpiled code 133 and the transpilation process. For example, the enrichment module is a system component within the transpilation process that enhances the meaning and value of the transformed code's output. The Enrichment Module injects additional information or context into the transpiled query code's output. This additional information aims to make the results more insightful and casier to understand for the user.

The module relies on a set of pre-defined functions. These functions determine the specific way the data will be enriched. There are two key stages where enrichment occurs:

### Testing Module—

During the testing phase of the transpilation process, the enrichment module utilizes pre-defined mock data.
This mock data simulates real-world data that the transformed code might encounter.
By using mock data, the module demonstrates how the enrichment process would work with real information.
This allows for a preliminary assessment of how the enriched output might look.

### Reconciliation Module—

During the reconciliation stage, the enrichment module leverages real contextual data.
This real data provides the most relevant information for enriching the output based on the specific query and context.
By using real data, the module ensures the enriched output is truly meaningful and valuable for the user.

The enrichment logic 132 may include pre-written code that is applied to the transpiled code 133 to enhance functionality and performance of the transpiled code 133. Each piece of enrichment logic 132 may be associated with metadata, such as an identifier (_id), a version number (_version), a name, the enrichment code itself, and an enrichment type. The enrichment logic 132 includes additional features or optimizations that were not present in the source code 102 but are nonetheless beneficial in the performance of the transpiled code 133. The enrichment logic 132 may be developed and tagged by the enrichment module 127 for easy lookup during the transpilation process. The enrichment module 127 may apply the enrichment logic 132 to the transpiled code 133 to provide additional functionality or to tailor the transpiled code 133 to specific requirements of the target distributed data processing system.

The operationalization module 128 may be configured to deploy and manage transpiled query code 133 within the system 100. In some embodiments, the operationalization module 128 may prepare the transpiled code 133 for production use. As a nonlimiting example, the operationalization module 128 may label the transpiled code 133 and store the transpiled code 133 in a target code repository. In some embodiments, the operationalization module 128 may perform an integrity check on the transpiled code 133. As a nonlimiting example, the operationalization module 128 may analyze the transpiled code 133 to determine that it integrates seamlessly within the target system. In other embodiments, the operationalization module 128 may manage the transpiled code's 133 lifestyle post-deployment.

The operationalization module is the system component that manages the integration, scheduling, monitoring, and feedback loop within the transpilation process. This module includes functionalities and configurations for seamless integration with the target system's telemetry (data collection) and deployment tools. Telemetry allows for capturing data on query execution and performance. In addition, this module is used to define the time and frequency at which the transpilation process runs. This ensures the transformation of queries occurs at the desired intervals.

The telemetry module plays a vital role in collecting and organizing data. The telemetry module logs the success or failure of all system operations for example pass or failed query translations. It is used to capture the performance metrics of these queries, such as execution time. Normalizes log formats, structures, and stores the collected data (query success, errors, performance, quality) in a standardized format. It uses query IDs or names for easy identification. This normalized data becomes valuable for analysis. The normalized telemetry data is accessible to the generative AI recommendation module. The generative AI module samples telemetry data to identify patterns and trends in query execution as part of its feedback mechanism. From a practical perspective, the operationalization module 128 operates to provide telemetry through tracked execution, for example, using coupled metadata and generating training pairs for re-training the machine learning module 151.

Based on the analyzed data, the generative AI system generates recommendations that may include:
Suspending Transpiled Code: If the data indicates performance or quality issues with transpiled queries, recommendations might suggest suspending their use in production environments.
Retranspilation with generative AI recommendations: The system might recommend re-running the transpilation process for specific queries using insights from generative AI analysis. This could involve optimizing the target code for better performance or data quality.
Redeployment of Updated Code: After retranspilation with generative AI recommendations, the improved target code can be redeployed back to the production system.

The operationalization module acts as the system's control center. It ensures smooth integration, sets the transpilation schedule, collects and normalizes telemetry data, provides it to generative AI for analysis, facilitates recommendations via the generative AI module to improve the overall effectiveness and efficiency of the transpilation process, integrates with the organization's CI/CD system to place target query code into service. This closed-loop approach allows for continuous learning and optimization of the system.

For example, the operationalization module 128 may update or modify the transpiled code 133 after deployment to address any bugs or errors in the transpiled code 133. The operationalization module 128 may deploy the transpiled code 133 to the production environment, ensuring that the transpiled code 133 is correctly placed within the system's architecture and that all dependencies are satisfied. Furthermore, the operationalization module 128 may apply the appropriate configurations for the transpiled code 133 to operate effectively in the target environment, which may include setting environment variables, tuning performance parameters, and configuring connections to other services or databases. The operationalization module 128 may continuously monitor the performance and health of the transpiled code 133 in the production environment, generating one or more alerts for any issues that may arise and transmitting those alerts to the one or more user devices 170. The operationalization module 128 may dynamically adjust resources allocated to the transpiled code 133 based on demand and performance metrics, ensuring efficient use of the system's capabilities.

The operationalization module 128 may also manage different versions of the transpiled code 133, allowing for rollbacks, staged rollouts, and A/B testing. The operationalization module also focuses on managing the deployment and effectiveness of the transpiled code. For example, the GenAI module might identify issues with deployed or in-service target code (e.g., poor performance or data quality). In such cases, the operationalization Module facilitates a rollback process:
The non-performing code is taken offline.
A newer version of the target code goes through the entire process: building, testing, reconciling, and delivering.
The offline code is labeled with a different version identifier and marked inactive, preventing accidental use.

The module allows for staged deployments, where the target code is rolled out to a limited audience before global release. This is achieved by configuring the operationalization Module with specific user or user group permissions:
The module can update permissions within the target system.
It restricts access to the new target code version for a designated group (e.g., development team) initially.
Once the staged rollout is deemed successful, the module can be configured for a global rollout.
This global rollout updates permissions to grant read and execution access for all users.

The operationalization Module can be used for A/B testing of different transpiled code versions. This helps determine which version performs best before full deployment:
The module configures the reconciliation process for each version being tested.
Reconciliation performance data is collected and normalized.
The generative AI recommendation system analyzes the data (including historical performance and reconciliation results).
Based on the analysis, the system recommends the best performing version of the transpiled code for deployment.

Overall, these functionalities within the operationalization module empower organizations to deploy and manage transpiled code effectively. They provide a safety net for rollbacks, allow for controlled testing with staged rollouts, and leverage A/B testing for data-driven decisions on which version to deploy. This ensures the delivery of high-performing and reliable transpiled code to the target system.

A/B testing is particularly useful in situations where the machine learning model does not have sufficient logit clearance as between two decisions (relating to readability, performance, errors), and automated A/B testing can occur where the machine learning model identifies bifurcation points for generating additional telemetry data that can be used to re-train and update the model. This type of A/B testing aids the system in improving an overall performance improvement speed.

For example, if releasing a new target transpiled query code:
Rollbacks: If the update causes issues, you can roll back to the previous version (taking offline the non-performing code and labeling it inactive).
Staged Rollouts: First deploy the update to a limited group of testers (user or user group) before releasing it to everyone (global rollout).
A/B Testing: Test two different versions of the update to see which one performs better (comparing two versions and recommending the best).

Additionally, the operationalization module 128 may enforce security policies and ensure that the transpiled code 133 complies with the system 100 security requirements. Furthermore, the operationalization module 128 ensure that the transpiled code 133 meets regulatory and compliance standards relevant to the industry and the nature of the data it processes. The operationalization module 128 may generate reports on the usage, performance, and outcomes of the transpiled code 133 to inform stakeholders and support decision-making.

The AI recommendation processor 150 may include a machine learning module 151 and recommendation module 152. The AI recommendation processor 150 may observe and analyze the transpilation attempts via the machine learning module 151 and generate one or more recommendations via the recommendation module 152. For example, the machine learning module 151 may analyze the source code execution module 122, testing module 125, reconciliation module 126, enrichment module 127, and the operationalization module 128 in an effort to improve the transpilation process. The recommendation module 152 is used for generating logit outputs that can be normalized and used for automated decision making between different transpilation options, determining which transpilation library and other features should be used for the generation of the transpiled code. Essentially, from a computational perspective, during the generation of the transpiled code, the recommendation module's pathfinding output can be invoked to select the path with the highest logit (e.g., using a case function instead of an if function, using object oriented variations classes), so that the system automatically tunes for improving efficiency opportunistically based on the different capabilities of the downstream execution. Similarly, the recommendation module 152, through iterative feedback as described herein in conjunction with the telemetry module and associated metadata, is adaptive to downstream performance problems or errors. In some embodiments, the recommendation module 152 can be used multiple times for the same transpilation operation, using different trained epochs of the machine learning backend as additional information is made available, tuning a same code transpilation based on tracked downstream usage of the code. As noted herein, this can be done on a test basis before ultimately being provided to production when sufficient performance is achieved, or time has elapsed.

During each of these modules' actions, the machine learning module 151 may observe and analyze each of the actions performed. For example, the machine learning module 151 can learn from previous transpilation processes, using machine learning algorithms to improve its future recommendations. By analyzing past successes and failures, the machine learning module 151 can refine its understanding of what constitutes effective transpiled code. Furthermore, the machine learning module 151 may predict the potential impact of changes to the transpiled code 133 and identify any risks or issues that might arise from the transpilation. Additionally, the machine learning module 151 may analyze the scalability of the transpiled code 133, providing insights into how the code will perform under different load conditions and suggesting improvements for handling large-scale data processing tasks.

Furthermore, the machine learning module 151 may use anomaly detection algorithms. The anomaly detection algorithms may include computational techniques designed to identify unusual patterns or outliers in the transpiled code 133 and transpilation process. For example, the detection of anomalous target query code structures uses a combination of distance metric functions and machine learning algorithms. The anomaly detector, associated with the machine learning code, begins by preparing data for analysis. This data encompasses two key components:
1. Abstract Syntax Tree (AST) and Semantic Analysis: These capture the structural and semantic characteristics of both the source code and the target query code. The AST represents the code's structure as a tree-like hierarchy, while semantic analysis delves into the code's meaning and functionality.
2. Normalization: To ensure all elements are represented on a comparable scale, the telemetry and AST data undergoes a normalization process. This allows for meaningful comparisons between different data points.

The system employs a multi-step approach to identify outliers within the prepared data. For instance, a distance metric function like the Mahalanobis distance, calculates the distance between individual data points within a high-dimensional dataset (the normalized data), for example, against a distribution. Unlike traditional distance metrics (e.g., Euclidean distance), the Mahalanobis distance metric incorporates the covariance between elements. The covariance reflects the inherent relationships between data points, providing a more nuanced understanding of their similarities or dissimilarities. The function utilizes the covariance matrix of the normalized dataset. This matrix encapsulates information derived from the ASTs and semantic analysis of both source and target code and also historical records of past query successes and failures.

By leveraging the covariance matrix, the Mahalanobis distance metric can assess the number of standard deviations a specific data point falls away from the “average” data point in the dataset (the distribution mean). This distance signifies the degree of deviation from the norm. To minimize the influence of potential outliers when calculating the mean and covariance matrix, the system employs a minimum covariance determinant (MCD) method. This method seeks to estimate these statistical values from a subset of the data statistically unlikely to contain anomalies.

The Mahalanobis distance metric function outputs a squared distance value (d\hat{ }2) for each data point relative to the reference samples (the normalized dataset). Higher squared distance values indicate a greater degree of dissimilarity from the norm. The distance between an observation and the mean can be calculated as below d=(y−μ) Σ−1 (y−μ). In the distance metric function, μ and Σ are the sample mean and covariance of the reference samples, respectively.

The system leverages the K-means clustering algorithm to group data points into a predefined number of clusters (k). K-means is an unsupervised machine learning technique that seeks to partition data points based on their inherent similarities. In this context, the system employs the Mahalanobis distance metric within the K-means algorithm. This ensures that data points within a cluster exhibit minimal distance from each other (based on their Mahalanobis distance). Conversely, the algorithm strives to maximize the distance between clusters, fostering distinct groupings. By grouping data points with similar characteristics, K-means facilitates the identification of outliers. Data points that exhibit significant deviations from existing clusters and struggle to fit into any established group are considered potential outliers. These outliers might represent unusual structures or potential issues within the transpiled code.

This approach offers several advantages. The combined use of the Mahalanobis distance metric and clustering, for example with K-Means, empowers the system to effectively identify outliers within the target query code structure.

The Mahalanobis distance metric's consideration of covariance fosters a more nuanced understanding of data point relationships, while K-means efficiently groups similar data together, making outliers stand out. By pinpointing potential anomalies in the transpiled code, the system enables engineers to investigate and address these issues.

This can lead to a more robust and efficient transpilation process, ultimately generating higher quality target query code. The system provides valuable insights into the structure and form of the transpiled code. This information can be leveraged by engineers to make data-driven decisions regarding code optimization and potential improvements. This system provides a valuable tool for detecting anomalous structures within transpiled code.

By combining distance metric functions and machine learning algorithms, the system empowers engineers to identify and address potential issues, ultimately leading to a more optimized and reliable transpilation process.

In the context of the transpilation process, these outliers could represent potential errors or areas that could benefit from optimization. During the transpilation process, the machine learning module 151 may systematically examine the transformation of the source code 102 into the transpiled code 133. In the context of this text, systematic examination refers to a multi-step, thorough, and structured analysis of the transpiled code governed by the operationalization module. It is not just a casual view, but a deliberate process designed to catch a wide range of issues. With the systematic examination process, the transpiled code is tested with real-world data to see if it produces the expected results. This is a simplified check to ensure the code functions at all. The system searches for unusual patterns in the code structure using the anomaly detector. A generative AI model analyzes the code's predicted functionality and performance. The model observes the code and also considers how similar code has performed in the past.

The systematic examination combines different approaches (test, reconciliation, anomaly detection, and generative AI analysis) to get a more complete picture of the code's quality, functionality, and performance. Each step has a specific purpose and builds upon the findings of the previous step. The examination considers both the code's structure (through AST analysis) and its predicted behavior (through generative AI analysis with historical data). With the systematic examination, the system catches issues with the transpiled code before it causes problems in production.

The machine learning module 151 may analyze each step of the transpilation, looking for deviations from the expected patterns. These deviations, or anomalies, could be indicative of potential issues such as syntax errors, logic errors, or performance inefficiencies in the transpiled code 133. By identifying these anomalies early in the process, the machine learning module 151 can flag potential areas for improvement of the transpiled code 133 and the overall transpilation process. Such a process may involve refining the transpilation logic, adjusting the configuration of the transpiler library content 101, or modifying the source code 102. In turn, the machine learning module may share or transmit its analyses and observations to the recommendation module 152. For example, the machine learning module 151 may transmit one or more processing inefficiencies associated with the transpilation of the source code 102. Then, the recommendation module 152 may generate one or more recommendation artifacts 160 to address these inefficiencies.

The recommendation module 152 may receive one or more analyses and observations from the machine learning module 151. Based on these analyses and observations, the recommendation module 152 may generate one or more recommendation of how to change the transpilation process to achieve a positive goal such as more efficient processing, less power consumed, and quicker processing.

These recommendations might include refactoring suggestions, algorithmic improvements to the transpilation process, or changes to data structures that could enhance performance or reduce resource consumption. The machine learning system can automatically recommend improvements to transpiled code, a process called refactoring. The machine learning system acts like a monitor, constantly analyzing the transpiled code.

It looks for two main signs that the code could be improved:
Performance Deviations: The system compares how the code performs against historical benchmarks. If the code runs slower than expected, it might be a candidate for refactoring.
Language/Structure Advancements: The system stays updated on the target query language (e.g., PySpark) and data structures. If newer versions offer improved functionalities for data processing or storage efficiency, it can recommend using those.

For example, consider an older version of PySpark functionality is used for the transpiled query code. The monitoring system might detect that a newer PySpark application programming interface library offers a more efficient function for aggregating data. It would then suggest refactoring the code to use the newer function, potentially improving performance and reducing resource usage. These recommendations are stored in a database and also published on the system's event bus notification system.

The benefits of the refactoring process include improved performance by using more efficient functionalities and data structures, the transpiled query code can run faster and use fewer resources. In addition, faster processing and lower storage needs can translate to cost savings for running the system. Moreover, refactoring with newer features keeps the code up to date with the latest advancements in the target language.

Overall, this machine learning system acts as an automated code reviewer, looking for ways to optimize the transpiled code based on historical performance data and the evolution of the target programming language. This can lead to significant improvements in the overall efficiency and cost-effectiveness of the system.

In other example embodiments, the recommendation module 152 may tailor its recommendations to the specifics of the target distributed data processing system, ensuring that the transpiled code 133 is not just syntactically correct but also optimized for the particular characteristics of the target environment.

Furthermore, the recommendation module 152 may produce one or more recommendation artifacts 160 that provide guidance on optimizing the testing, reconciliation, enrichment, and operationalization of the query code on the target distributed query processing system. The recommendation artifacts 160 may include without limitation such as error rates, compute configuration suggestions, estimated execution times, and targeted improvements for scalability and performance. For example, the system communicates recommendations for improving the transpiled code (discussed previously) to the target query processing system. Recommendations are packaged in JSON (JavaScript Object Notation). JSON is a common way to store and exchange data because it's easy for both humans and computers to understand. The system publishes the JSON data containing metrics (e.g., performance data) and recommendations onto an “event bus.” The event bus serves as a central messaging system that allows different parts of the software to communicate with each other. The system is configured to interoperate with the organization's event bus.

When the system is first set up, it connects to the event bus allowing messages to be exchanged with the organization. The organization “listens” for messages on the event bus and makes changes, if recommended, to the target querying processing system. When it receives a message containing recommendations in JSON, it processes the information. The recommendations can be for different target objectives, such as:
Resource Allocation: Increasing CPU or memory for specific queries based on recommendations. The target querying processing system reads the specific values for CPU and memory from the JSON message and updates the configuration accordingly.
Refactoring Code: Recommendations might suggest changes to the transpiled code itself. The target querying processing system uses APIs (application programming interfaces) to execute these refactoring suggestions.

The system generating recommendations and the target system do not need to be directly connected. Decoupling the system makes the overall software architecture more flexible and easier to maintain. JSON provides a common format for exchanging data, making it easier for different parts of the system to understand each other.

These recommendation artifacts 160 may be stored for later review in a database 161. One or more user devices 170 may retrieve or receive the recommendation artifacts 160 for review and analysis.

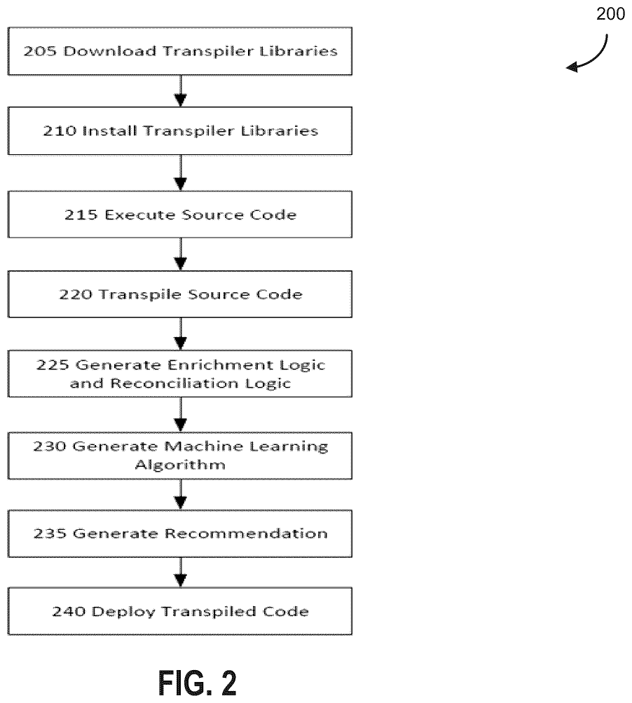

FIG. 2 is a flow diagram illustrating a method 200 of generating one or more recommendations for improving the transpiled code 133, according to example embodiments. Each step in the method 200 may be performed by the server 180 via the transpiler processor 120 and the AI recommendation processor 150.

At step 205, the transpiler library management module 121 may download transpiler library content 101 and source code 102. In some embodiments, the transpiler library management module 121 may retrieve the transpiler libraries from an internal software management system, an external web URL, or a company's file storage system. The transpiler library management module 121 may select the appropriate library version and target operating system before initiating the download. Once the libraries are downloaded, they may be configured to align with the system's requirements.

At step 210, the transpiler library management module 121 may install the transpiler libraries. This installation process is tailored to the specific requirements of the target computing environment. This ensures that the libraries are compatible with the system and can function effectively within it.

At step 215, the source code execution module 122 may execute the source code 102. During this step, the source code execution module 122 may perform a comprehensive analysis of the code's performance and the review of its results. In some embodiments, the source code execution module 122 may engage in semantic analysis of the source code 102. For example, once the code is parsed into an AST, the source code execution module 122 may perform one or more semantic analyses to understand the meaning of the code. This may involve checking for semantic errors, resolving variable and function names, and ensuring that operations are valid according to the language's rules. The machine learning module 151 may analyze the source code execution to look for opportunities to increase efficiency in the transpilation process.

At step 220, the source code transpilation module 123 transpiles the source code 102 into the transpiled code 133. The transpilation process involves parsing the source code, understanding its syntax and semantics, and generating equivalent code in the target language. The transpiler library content 101 provide the functionality to perform this translation, leveraging their understanding of both the source and target languages to ensure an accurate conversion. At step 225, the reconciliation module 126 may generate one or more reconciliation logic 131 and the enrichment module 127 may generate one or more enrichment logic 132. Enrichment logic 132 snippets from the enrichment logic repository are applied to the transpiled code 133 to enhance its functionality. Reconciliation logic 131 from the reconciliation logic repository is used to test and verify the transpiled code 133, ensuring accuracy and integrity of the transpiled code 133.

At step 230, the machine learning module 151 analyzes the source code execution process and the transpilation process. For example, the machine learning module 151 may analyze the transpiled code 133 to identify patterns, inefficiencies, and potential areas for improvement. After this analysis, at step 235 the recommendation module 152 may generate one or more recommendation artifacts 160 via the recommendation module 152 for optimization stored in a target execution folder or database 161. The source code transpilation module 123 may also generate one or more enrichment logic 132 and reconciliation logic 131 via the enrichment module 127 and reconciliation module 126, respectively. At step 240, the transpiled code execution module 140 may execute the transpiled code 133.

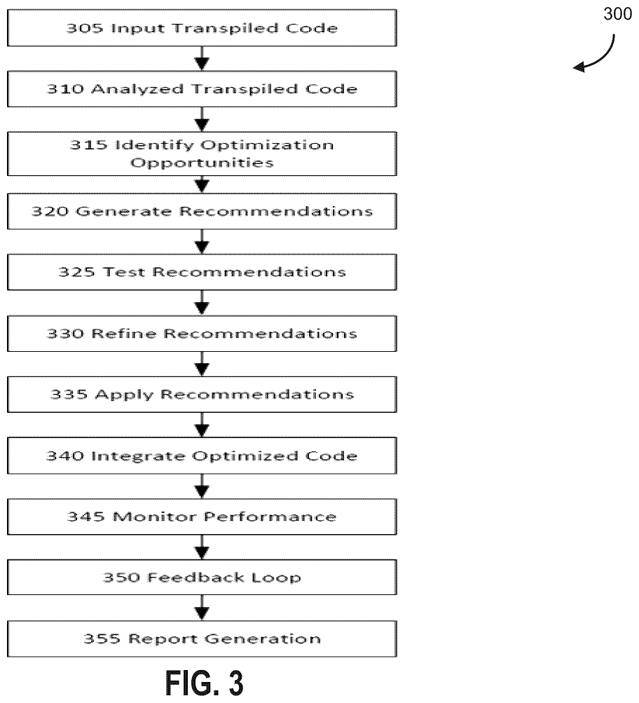

FIG. 3 is a flow diagram illustrating a method 300 of generating and integrating recommendations to improve the transpiled code 133 and the transpilation process, according to example embodiments. Each step in the method 300 may be performed by the server 180 through the AI recommendation processor 150, and further through the machine learning module 151 and the recommendation module 152.

At step 305, the machine learning module 151 receives the transpiled code 133 as input after it has been processed by the transformation module 124. The transpiled code 133 is the result of the transpilation process, which involves translating source code 102. In other example embodiments, the machine learning module 151 could receive the transpiled code 133 from various sources, such as a code repository, a file storage system, or directly from the source code transpilation module 123. The transpiled code 133 could also be received in different formats, such as text files, binary files, or packaged in a container for deployment.

At step 310, the machine learning module 151 performs an analysis of the transpiled code 133, examining its structure, logic, and performance characteristics. This analysis is designed to understand the transpiled code 133 and identify potential areas for optimization. In some example embodiments, the machine learning module 151 could use different analysis techniques, such as static code analysis, dynamic code analysis, or machine learning algorithms. The analysis could also focus on different aspects of the code, such as its syntax, semantics, control flow, data flow, or resource usage. The analysis may be performed one or more times. As a nonlimiting example, the machine learning module 151 may analyze the code after every iteration or version of the transpiled code 133, wherein each iteration or version of the transpiled code 133 has been injected with one or more enrichment logic 132 and reconciliation logic 131.

At step 315, the machine learning module 151 may identify potential areas for optimization, such as inefficient code patterns, opportunities for parallel processing, or algorithmic improvements. These optimization opportunities are designed to improve the performance or efficiency of the transpiled code 133. In example embodiments, the machine learning module 151 could identify different types of optimization opportunities, such as reducing memory usage, minimizing network latency, or improving security. The machine learning module 151 could also use different criteria to identify optimization opportunities, such as code complexity, execution time, or resource consumption.

At step 320, the recommendation module 152 may generate one or more recommendations for optimizing the transpiled code 133. These may include code refactoring, algorithmic changes, or adjustments to data structures associated with the transpiled code 133. The recommendations are designed to improve the performance or efficiency of the transpiled code 133. In example embodiments, the recommendation module 152 could generate different types of recommendations, such as changing the programming paradigm, using different data types, or adopting different coding standards in the transpilation process. The recommendations could also be prioritized based on different factors, such as the potential performance gain, the complexity of the change, or the impact on other parts of the code. The recommendation module 152 may store the recommendation artifacts 160 in the database 161.

At step 325, the machine learning module 151 may test the proposed optimizations to ensure they do not introduce new errors and that they actually improve the performance or efficiency of the transpiled code 133. This testing process is designed to validate the recommendations and ensure their effectiveness in the transpiled code 133. In some embodiments, the machine learning module 151 may use different testing techniques, such as unit testing, integration testing, or performance testing. The testing process could also involve different steps, such as setting up a test environment, executing the tests, or analyzing the test results.

At step 330, the machine learning module 151 refines the recommendations. For example, and as stated earlier, recommendations are communicated over the event bus and also can be stored in a database. Over time, recommendations for resource allocation (CPU and memory) might become inaccurate due to changes, e.g., in data volume, target system architecture, or target system language functionality. This can lead to negative consequences:
Insufficient Resources: If not enough CPU or memory is allocated, the queries might fail or take too long to process.
Wasted Resources: If too much memory is allocated, processing time might not improve significantly, leading to wasted resources.

To address recommendation decay, the system periodically, under the governance of the operationalization module, retrains the machine learning model responsible for suggesting resource allocation. The system gathers historical data, including:
Shared Recommendations: Past recommendations for CPU and memory allocation.
Performance/Functionality History: Information on how the queries actually performed (e.g., execution time, success/failure) when those recommendations were applied.

This data is then processed to ensure all features are represented in a consistent format suitable for machine learning. The machine learning model takes this normalized dataset consisting of features such as:
target_query_name,
recomm_cpu_value,
recomm_mem_value,
actual_cpu, actual_me,
avg_CPU_query_code_value,
avg_MEM_query_code_value,
avg_duration,
succeeded.

The model produces new recommendations artifacts based on the new set of information. The normalized data is used to retrain the machine learning model. The retrained model produces a new set of recommendations based on the updated information. Retraining provides benefits such as:
Improved Accuracy: By retraining with historical data, the model can learn from past recommendations and suggest more accurate resource allocations in the future.
Reduced Resource Waste: More accurate recommendations can help avoid situations where too much or too little resources are allocated.
Enhanced Query Performance: By providing the right amount of resources, the system can ensure queries run efficiently and successfully.

The system recognizes that recommendations can become outdated. To address this, it employs a feedback loop where historical data is used to continuously refine the machine learning model and improve the accuracy of its recommendations. This helps optimize resource allocation and overall query performance.

In some example embodiments, the machine learning module 151 can iterate the process to maximize the effectiveness of the optimizations. This refinement process is designed to improve the quality of the recommendations and ensure their suitability for the transpiled code 133. In example embodiments, the machine learning module 151 could use different refinement techniques, such as genetic algorithms, gradient descent, or simulated annealing. The refinement process could also involve different steps, such as evaluating the fitness of the recommendations, selecting the recommendations for the next iteration, or mutating the recommendations.

At step 335, the machine learning module 151 may apply the recommendations to the transpiled code 133 to create an optimized version. This application process is designed to implement the optimizations and improve the performance or efficiency of the transpiled code 133. In example embodiments, the machine learning module 151 may apply the recommendations in different ways, such as modifying the source code 102, generating a new version of the transpiled code 133, or applying the optimizations at runtime. The application process could also involve different steps, such as preparing the source code 102 or transpiled code 133 for modification, applying the recommendations, or verifying the correctness of the modified source code 102 and transpiled code 133.

At step 340, machine learning module 151 the optimized code is integrated into the transpiled code 133, replacing or supplementing the original transpiled code. This integration process is designed to deploy the optimized code and ensure its compatibility with a target system. The machine learning module 151 could integrate the optimized code in different ways, such as replacing the original code, running the optimized code alongside the original code, or gradually phasing in the optimized code. The integration process could also involve different steps, such as preparing the target system for integration, deploying the optimized code, or verifying the successful integration of the optimized code.

At step 345, the machine learning module 151 monitors the performance of the optimized code to ensure that the expected improvements are realized. This monitoring process is designed to track the performance of the optimized code and identify any issues that may arise. The machine learning module 151 may monitor different aspects of the performance, such as execution time, resource usage, or error rates. The monitoring process could also involve different steps, such as setting up monitoring tools, collecting performance data, or analyzing the performance data.

At step 350, performance data and any issues encountered are fed back into the machine learning module 151, allowing it to learn and improve its recommendations for future transpilation tasks. This feedback loop is designed to continuously improve the performance of the machine learning module 151 and ensure its effectiveness in optimizing transpiled code 133. The machine learning module 151 could use different feedback mechanisms, such as reinforcement learning, supervised learning, or unsupervised learning. The feedback loop could also involve different steps, such as collecting feedback data, updating the recommendation algorithms, or retraining the machine learning intelligence.

At step 355, the machine learning module 151 may generate detailed reports on the optimization process, including the nature of the recommendations, the performance gains achieved, and any lessons learned. These reports may be stored for future reference and analysis. This reporting process is designed to provide transparency and accountability for the optimization process and inform future transpilation tasks. The machine learning module 151 could generate different types of reports, such as summary reports, detailed reports, or interactive dashboards. The reports could also include different information, such as the number of recommendations made, the success rate of the recommendations, or the impact of the optimizations on the overall system performance.

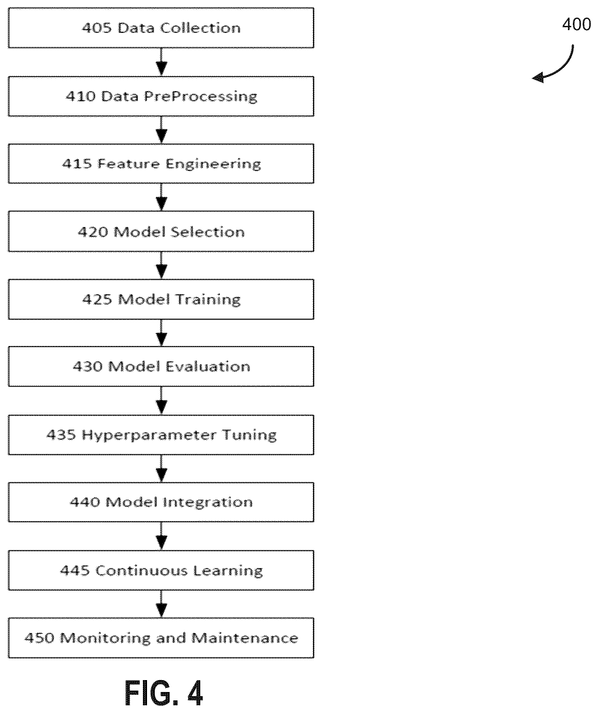

FIG. 4 is a flow diagram illustrating a method 400 of generating and monitoring a machine learning model, according to example embodiments. Each step in the method 400 may be performed by the server 180 through the AI recommendation processor 150 via the machine learning module 151 and the recommendation module 152.

At step 405, the machine learning module 151 may compile data from past transpilation projects. This data may include source code 102, transpiled code 133, performance metrics, and any optimization recommendations that were made during the transpilation process. This data may serve as the foundation for training the machine learning model. In some example embodiments, the data may include additional information such as system logs, error reports, or user feedback, which could provide further insights into the transpilation process and its outcomes. At step 410, the machine learning module 151 may preprocess the collected data to ensure it is in a consistent and usable format. This may involve cleaning the data, handling missing values, and converting the data into a structured form. In example embodiments, other data preprocessing techniques such as normalization, discretization, or feature extraction could be used to further refine the data and prepare it for the subsequent steps. At step 415, the machine learning module 151 identifies and extracts relevant features the preprocessed data. These features could include syntactic elements of the code, complexity metrics, execution times, and any specific characteristics of the source code 102 and the target code 133. Additional features may be engineered based on domain knowledge or using automated feature selection techniques. These features could provide additional insights into the transpilation process and enhance the predictive power of the machine learning models.

At step 420, the machine learning module 151 may choose appropriate machine learning algorithms based on the nature of the transpilation process and the desired outcomes. The selection could range from regression models for predicting performance metrics to classification models for identifying code optimization opportunities. Other types of machine learning models such as decision trees, neural networks, or ensemble methods may be used depending on the complexity of the problem and the characteristics of the data. At step 425, the machine learning module 151 trains the selected models using the prepared dataset. This step may involve feeding the features into the models and adjusting the model parameters to minimize the error between the predicted and actual outcomes. The training process may utilize a combination of supervised, unsupervised, and reinforcement learning techniques. Other training techniques such as transfer learning, active learning, or online learning could be used to enhance the efficiency and effectiveness of the training process. The training data may include past transpilation attempts, including both successful and unsuccessful transpilations. In some embodiments, each transpilation attempt may be represented as a data point, with features such as the source code, the target code, the transpiler libraries used, the transpilation process parameters, and the outcome of the transpilation attempt. The outcome could be a binary success/failure indicator, or a more detailed measure such as the execution time of the transpiled code, the error rate, or the resource usage. The algorithm learns to associate specific types of enrichment logic 132 and reconciliation logic 131 with successful transpilation outcomes and uses this knowledge to generate recommendations for future transpilations. Feedback data collected during the execution of the transpiled code 133 is another valuable source of training data for the algorithm. This feedback data includes metrics such as the execution time, the error rate, and the resource usage of the transpiled code 133. The machine learning algorithm uses this feedback data to learn how different transpilation parameters and strategies affect the performance of the transpiled code 133 and uses this knowledge to generate optimization recommendations.

At step 430, the machine learning module 151 may assess the performance of the trained models. The models are evaluated based on accuracy, precision, recall, and other relevant metrics to ensure that they can generate reliable recommendations. Other evaluation techniques such as cross-validation, bootstrapping, or ROC analysis could be used to provide a more robust assessment of the model's performance.

At step 435, the machine learning module 151 may optimize the models by tuning hyperparameters, which are the configuration settings that govern the training process of the machine learning algorithm. Techniques such as grid search or random search can be used to find the hyperparameter values that yield the best model performance. In other example embodiments, other hyperparameter tuning techniques such as Bayesian optimization, genetic algorithms, or gradient-based optimization could be used to further enhance the performance of the models. At step 440, once the models are trained and validated, the machine learning module 151 may integrate these new models into the transpilation process. The machine learning module 151 is designed to access the transpiled code 133 and other relevant data during the transpilation process to apply the trained models in real-time.

At step 445, the machine learning module 151 may implement a feedback loop in which the machine learning module 151 may learn from new transpilation attempts. As the system transpiles new code and receives feedback on the effectiveness of its recommendations, the models are retrained with updated data to improve their accuracy and relevance. The feedback loop may be enhanced with active learning techniques, where the system actively seeks out new data that is expected to improve its performance. At step 450, the machine learning module 151 may regularly monitor performance of the machine learning model to ensure it continues to provide valuable insights. Maintenance tasks such as retraining models with new data, updating algorithms, and refining features are performed to adapt to changes in the transpilation environment. In alternative embodiments, the monitoring and maintenance process could be automated using machine learning techniques, allowing the system to self-adapt and self-improve over time.

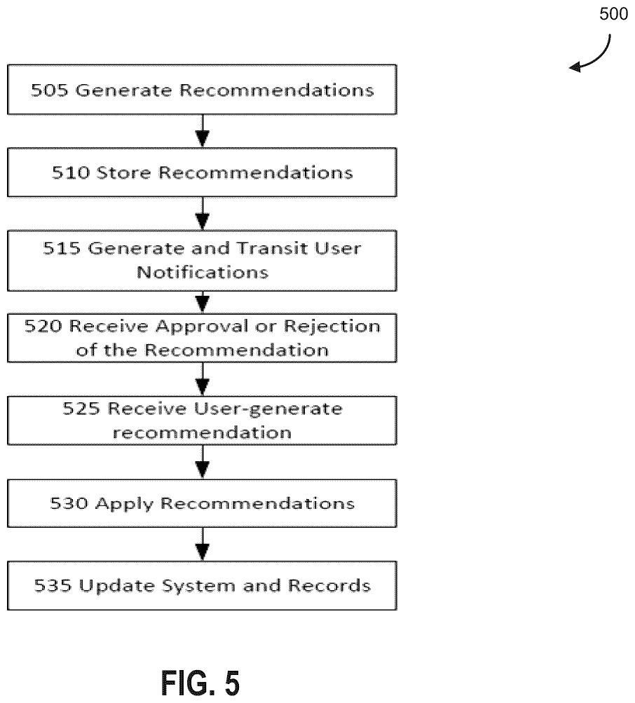

FIG. 5 is a flow diagram illustrating a method 500 of generating recommendations, receiving feedback from users, and applying the feedback to the transpiled code 133 and transpilation process, according to example embodiments. Each step in the method 500 may be performed by the server 180 through the AI recommendation processor 150, and further through the machine learning module 151 and the recommendation module 152.

At step 505, the recommendation module 152 may generate recommendations aimed at improving the efficiency, performance, or other aspects of the transpiled code 133 and transpilation process. These recommendations may include code refactoring, algorithmic changes, or adjustments to data structures associated with the transpiled code 133. In some example embodiments, the recommendation module 152 could generate different types of recommendations, such as changing the programming paradigm, using different data types, or adopting different coding standards in the transpilation process.

At step 510 the machine learning module 151 may store the generated recommendations, also known as recommendation artifacts 160, in a database 161. The database 161 is accessible to user devices 170, allowing for easy retrieval and review of the recommendations. The storage of these recommendations ensures that they are preserved for future reference. In some example embodiments, the recommendation module 152 may even transmit the recommendation artifacts 160 to the user devices 170 over a wired or wireless network.

At step 515, following the storage of the recommendations, the machine learning module 151 may notify the user devices 170 the availability of the recommendations. These notifications can be sent through various communication channels integrated with the system, such as an event bus or email. This step ensures that the users are made aware of the recommendation artifacts 160 and can review them at their earliest convenience. In other embodiments, users can then retrieve the recommendation artifacts 160 from the database using their user devices 170. This retrieval can be done either through a direct query to the database 161 or via a user interface that presents the available recommendations. This step provides users with easy access to the recommendations and allows them to review them in detail. Once the recommendations have been retrieved, users review them on their user devices 170. During this review, users consider the suggested changes, and the potential impacts these changes could have on the transpiled code 133. This step allows users to gain a comprehensive understanding of the recommendations and their implications.

At step 520, the machine learning module 151 may receive feedback from one or more users via the user devices 170. This feedback could include approval of the recommendations, requests for modifications, or rejection of the recommendations. This step ensures that user feedback is considered and that the recommendation artifacts 160 are refined based on this feedback. At step 525, the machine learning module 151 may even receive a recommendation that the user generated. The user-generated recommendations can also include code refactoring, algorithmic changes, or adjustments to data structures associated with the transpiled code 133. In example embodiments, the user-generated recommendations may include changing the programming paradigm, using different data types, or adopting different coding standards in the transpilation process. At step 530, the machine learning module 151 may apply the recommendations to the transpiled code 133 and the transpilation process. For example, if the recommendations are approved by the user, then the machine learning module 151 may apply those approved recommendations to the transpiled code 133 and the transpilation process. As another example, if machine learning module 151 receives user-generated recommendations, the machine learning module 151 may proceed to apply them to the transpiled code 133. In some embodiments, if modifications to the transpiled code 133 are requested by the user, the machine learning module 151 may re-analyze the code and generate revised recommendations. This step ensures that the recommendations are tailored to the specific requirements of the users and that they are optimized based on user feedback.

At step 535, machine learning module 151 may update its records to reflect the applied recommendations and their approval status. This ensures traceability and accountability for changes made to the transpiled code 133. This step provides a record of the optimization process and allows for easy tracking of the changes made to the transpiled code 133.

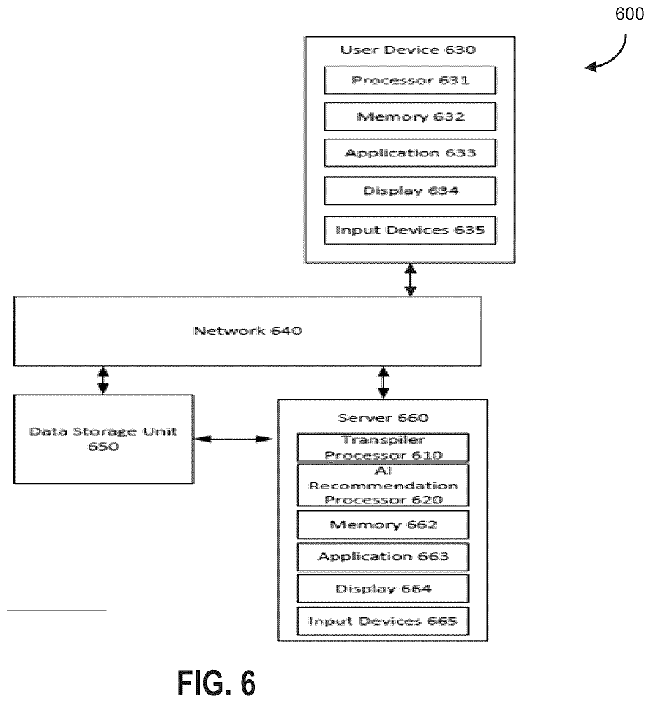

FIG. 6 illustrates a system 600 according to an example embodiment. The system 600 may include a user device 630, network 640, data storage unit 650, and a server 660. Although FIG. 1 illustrates single instances of components of system 100, system 100 may include any number of components.

The system 600 can include one or more user devices 630. The user device 630 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 630 may include a processor 631, a memory 632, and an application 633. The processor 631 may be a processor, a microprocessor, or other processor, and the user device 630 may include one or more of these processors. The processor 631 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 631 may be coupled to the memory 632. The memory 632 may be a read-only memory, write-once read-multiple memory or read/write memory, e.g., RAM, ROM, and EEPROM, and the user device 630 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 632 may be configured to store one or more software applications, such as the application 633.

The application 633 may include one or more software applications, such as a mobile application and a web browser, including instructions for execution on the user device 630. In some examples, the user device 630 may execute one or more applications, such as software applications, that enable, for example, network communications with one or more components of the system 600, transmit and/or receive data, and perform the functions described herein. Upon execution by the processor 631, the application 633 may provide the functions described in this specification, specifically to execute and perform the steps and functions in the process flows described below. Such processes may be implemented in software, such as software modules, for execution by computers or other machines. The application 633 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The user device 630 may be associated with one or more of a display 664 or input devices 635. The display 634 may be any type of device for presenting visual information such as a computer monitor, a flat panel display, and a mobile device screen, including liquid crystal displays, light-emitting diode displays, plasma panels, and cathode ray tube displays. The input devices 635 may include any device for entering information into the user device 630 that is available and supported by the user device 630, such as a touchscreen, keyboard, mouse, cursor-control device, touchscreen, microphone, digital camera, video recorder or camcorder. These devices may be used to enter information and interact with the software and other devices described herein.

System 600 may include one or more networks 640. In some embodiments, the network 640 may be one or more of a wireless network, a wired network or any combination of wireless network and wired network and may be configured to connect the user device 630, the server 660, the transpiler processor 610, and database or data storage unit 650. For example, the network 640 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 640 may include, without limitation, telephone lines, fiber optics, IEEE Ethernet 902.3, a wide area network, a wireless personal area network, a LAN, or a global network such as the Internet. In addition, the network 640 may support an Internet network, a wireless communication network, a cellular network, or the like, or any combination thereof. The network 640 may further include one network, or any number of the exemplary types of networks mentioned above, operating as a stand-alone network or in cooperation with each other. The network 640 may utilize one or more protocols of one or more network elements to which they are communicatively coupled. The network 640 may translate to or from other protocols to one or more protocols of network devices. Although the network 640 is depicted as a single network, it should be appreciated that according to one or more examples, the network 640 may include a plurality of interconnected networks, such as, for example, the Internet, a service provider's network, a cable television network, corporate networks, such as credit card association networks, and home networks. The network 640 may further include, or be configured to create, one or more front channels, which may be publicly accessible and through which communications may be observable, and one or more secured back channels, which may not be publicly accessible and through which communications may not be observable.

System 600 may include a database or data storage unit 650. The database or data storage unit 650 may include a relational database, a non-relational database, or other database implementations, and any combination thereof, including a plurality of relational databases and non-relational databases. In some examples, the database or data storage unit 650 may include a desktop database, a mobile database, or an in-memory database. Further, the database or data storage unit 650 may be hosted internally by the server 660 or may be hosted externally of the server 660, such as by a server, by a cloud-based platform, or in any storage device that is in data communication with the server 660.

The system can include a server 660. The server 660 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. The server may be a combination of one or more cloud computing systems such as public clouds, private clouds, and hybrid clouds.

The server 660 may include a transpiler processor 610, an AI recommendation processor 620, a memory 662, and an application 663. The transpiler processor 661 may be a processor, a microprocessor, or other processor, and the server 660 may include one or more of these processors. The transpiler processor 610 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein. Similarly, the AI recommendation processor 620 may be a processor, a microprocessor, or other processor, and the server 660 may include one or more of these processors. The AI recommendation processor 620 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The transpiler processor 610 and AI recommendation processor 620 may be coupled to the memory 662. The memory 662 may be a read-only memory, write-once read-multiple memory or read/write memory, e.g., RAM, ROM, and EEPROM, and the server 660 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 662 may be configured to store one or more software applications, such as the application 663.

The application 663 may include one or more software applications, such as a mobile application and a web browser, including instructions for execution on the server 660. In some examples, the server 660 may execute one or more applications, such as software applications, that enable, for example, network communications with one or more components of the system 600, transmit and/or receive data, and perform the functions described herein. Upon execution by the processor 661, the application 663 may provide the functions described in this specification, specifically to execute and perform the steps and functions in the process flows described below. Such processes may be implemented in software, such as software modules, for execution by computers or other machines. The application 663 may provide graphical user interfaces (GUIs) through which a user may view and interact with other components and devices within the system 600. The GUIs may be formatted, for example, as web pages in HyperText Markup Language (HTML), Extensible Markup Language (XML) or in any other suitable form for presentation on a display device depending upon applications used by users to interact with the system 600.

The server 660 may further include a display 664 and input devices 665. The display 664 may be any type of device for presenting visual information such as a computer monitor, a flat panel display, and a mobile device screen, including liquid crystal displays, light-emitting diode displays, plasma panels, and cathode ray tube displays. The input devices 665 may include any device for entering information into the server 660 that is available and supported by the server 660, such as a touchscreen, keyboard, mouse, cursor-control device, touchscreen, microphone, digital camera, video recorder or camcorder. These devices may be used to enter information and interact with the software and other devices described herein.

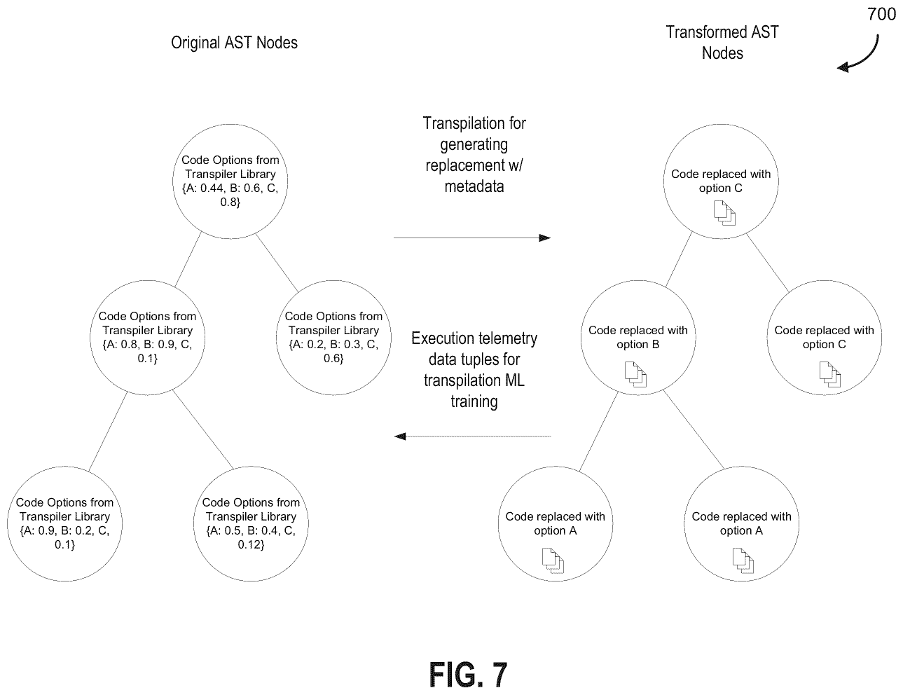

FIG. 7 is a pictogram 700 of an example AST being transformed into equivalent code as part of the transpilation, according to some embodiments. The system can receive the initial source code in a first language, identify the origin and target programmatic languages, and identify/load relevant transpiler libraries.

In this example, an initial source code is first decomposed into an initial AST, shown on the left side of the diagram. As part of the decomposition process, the underlying structure of the code is parsed and interrogated to generate a data structure of nodal elements, interconnected with one another. The data structure of nodal elements can include variables, code portions, function calls, etc.

For each nodal element, the system is configured to interrogate a transpiler library to identify candidate equivalent code portions in the target language. As shown in the simplified example of 700, there can be different options for transpilation that are available, and these can be due to different available structure and characteristics as between the initial language and the target language, having different performance attributes. For example, one of the programmatic languages may have increased performance efficiency, while another programmatic language may have additional available helper functions (e.g., garbage collection daemon processes for automatic memory management). Similarly, different types of code equivalents may be available that can be used to perform a same task, such as different options for iteratively looping code, different variable types, different available data sources for a same variable.

As described in embodiments above, a machine learning engine is instantiated and is trained to maintain a representation in a latent space through training iterations. In FIG. 7, the code options are assigned a logit value from the machine learning engine representative of a predicted best equivalent code replacement, and a highest logit is selected as the option for an initial transpilation to generate the transformed AST nodes.

This output code is coupled with the associated data structure and transpilation selection options as an output object having extended metadata representative of the machine learning outputs and selections.

As the output code is executed by downstream processes, telemetry and performance data as described above is tracked such that, for example, a weighted objective function can be optimized as part of the re-training of the machine learning engine's represented latent space, such that future transpilation attempts benefit from modified transpilation decisions using the re-trained latent space using feedback.

In some embodiments, the re-training of the latent space can be conducted periodically for improved code transpilation decision stability. In other embodiments, the re-training of the latent space can be conducted in real or near real time to allow for a continuously shifting machine learning representation.

In a variant embodiment, the system is configured for automatic re-transpilation attempts where performance errors are identified or overall performance falls below a performance threshold using a later version of the trained machine learning data representation. By conducting automatic re-transpilation, the system can be configured to effectively automatically adjust and attempt to self-heal programmatic errors or performance issues that arise through using updated iterations of the machine learning representation as new telemetry and performance information is automatically considered and used for updating.

If the machine learning engine is instantiated as an untrained machine learning instance, in some embodiments, a training process may also occur whereby transpilation attempts are conducted and executed in a non-production or mock environment for a period of time, and errors/performance is used in this environment for automatic tuning of the machine learning instance to establish the first trained variation that can be used for production purposes. In some embodiments, the transpilation attempts are contained in the non-production or mock environment until a pre-defined performance threshold or objective function level can be reached (e.g., on a rolling average) for code execution.

The system can be configured as a standalone transpilation computer server that is a physical computing appliance that is coupled to a message bus that receives source code for transpilation through a corresponding application programming interface. The system references a transpilation library for code conversion and transformation, and where multiple options are available, selection between the options is conducted based on machine learning engine outputs using a trained machine learning model. The system can then conduct the transformation of the code using the selected transpiler library replacement functions, outputting a data set representative of the transformed code along with decision metadata.

The decision metadata can either be provided alongside the transformed code as an output, or the records of the transpilation and decisions thereof can be stored in local or coupled storage. During downstream execution of the code, a performance/error management daemon process can be coupled to obtain telemetry and performance data during the actual execution to be provided periodically through the message bus to the system. The system receives the data sets to establish ground truth supervised training pairs for re-training the machine learning representations.

In some embodiments, the transpilation process can be automatically re-initiated for code that encounters sub-optimal performance or errors during execution, automatically invoking a replacement function after the original transpiled code had failed. In the example of FIG. 7, a failed option can effectively be used to re-train the system to severely penalize the transpilation option so that a different equivalent code is used for the transformation in the re-initiated transpilation to generate the replacement. Accordingly, the system can be configured to incorporate an aspect of machine automated exploration and replacement of failed code variations in an attempt to improve performance without having to explicitly establish transpilation decisions.

A set of machine learning representations can be maintained at once, each representation coupled for different transpiler libraries and/or different language or computing architecture pairings. Because different computing architectures, and languages have different functional characteristics, this allows for the system to automatically adapt without the need for explicit programming of rules as between different pairings.

This is very useful in a very large enterprise environment, where there is a high volume of code transpilation required, for example, as there is a shift from legacy systems, and a corresponding opportunity to automatically attempt to optimize code transformations. Mock and non-production environments can be used for training when there is not sufficient confidence as measured through performance thresholds of the trained machine learning model to avoid impacting production systems. In a further variation, transpiled code can also be segregated for operation for a period of time in a quarantined non-production sandbox for execution, and once the performance measurement data process is greater than a pre-defined threshold, an automated decision can be made to either graduate the transpiled code for production usage, or to conduct re-training and re-transpilation (e.g., due to execution errors). This is useful in situations where there is not enough training data available and less confidence in the transpilation engine.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A computer implemented system for automated transpilation of query source code by transforming an initial source code provided in an initial programmatic language into an output source code provided in a target programmatic language, the system comprising:
a computer processor operating in conjunction with a non-transitory computer readable medium storing computer interpretable instruction sets, the computer processor configured to:
decompose the initial source code to generate a syntax tree (AST) data structure, the AST data structure representing programmatic constructs within the initial source code as nodes of a plurality of nodes of the AST data structure;
maintain a trained machine learning data model architecture, coupled to a transpiler library, trained for controlling transpilation between the initial programmatic language and the target programmatic language;
process the AST data structure using the trained machine learning data model architecture to automatically identify equivalent code for transpilation of each node of the AST data structure between the initial programmatic language and the target programmatic language; and
generate the output source code in the target programmatic language;
wherein upon identifying a plurality of available transpilation options in the transpiler library during the identification of equivalent code, the trained machine learning data model is configured to generate output logits corresponding to each available transpilation option, the available transpilation option of the with a highest output logit being selected as the equivalent code for generation of the output source code in the target programmatic language.

2. The system of claim 1, wherein the output source code in the target programmatic language is coupled with telemetry metadata representative of the plurality of available transpilation options and the selected available transpilation option used for the selection of the equivalent code; and wherein the trained machine learning data model architecture is retrained using a combination of performance data and the telemetry metadata representative of the plurality of available transpilation options.

3. The system of claim 2, wherein the performance data includes data sets extracted from daemon processes monitoring processing errors associated with downstream execution of the output source code.

4. The system of claim 2, wherein the performance data includes data sets extracted from daemon processes monitoring processing speed associated with downstream execution of the output source code.

5. The system of claim 2, wherein the performance data includes data sets extracted from daemon processes monitoring a weighted average of processing speed and processing errors associated with downstream execution of the output source code, the weighted average representing an objective function being minimized during retraining of the trained machine learning data model architecture.

6. The system of claim 5, wherein the retraining of the trained machine learning data model architecture is conducted in real or near-real time as errors or processing speed issues are identified during the downstream execution of the output source code, causing the trained machine learning data model architecture to be trained in accordance with a real-time feedback loop.

7. The system of claim 2, wherein the performance data includes data sets extracted from daemon processes monitoring processor load associated with downstream execution of the output source code.

8. The system of claim 2, wherein the performance data includes data sets extracted from daemon processes monitoring memory usage associated with downstream execution of the output source code.

9. The system of claim 2, wherein during a pre-training duration after instantiation of an untrained machine learning data model architecture, the downstream execution is conducted on a non-production environment simulating real-world usage and the untrained machine learning data model architecture is first trained during execution in the non-production environment to establish the trained machine learning data model architecture for usage in a production environment.

10. The system of claim 1, wherein the computer implemented system is a special purpose computing machine operating in a data center coupled to a message bus having an application programming interface for receiving data sets representative of the initial source code and for providing the output source code as output data sets to a distributed data processing or query system.

11. A computer implemented method for automated transpilation of query source code by transforming an initial source code provided in an initial programmatic language into an output source code provided in a target programmatic language to a distributed data processing or query system, the method comprising:
decomposing the initial source code to generate a syntax tree (AST) data structure, the AST data structure representing programmatic constructs within the initial source code as nodes of a plurality of nodes of the AST data structure;
maintaining a trained machine learning data model architecture, coupled to a transpiler library, trained for controlling transpilation between the initial programmatic language and the target programmatic language;
processing the AST data structure using the trained machine learning data model architecture to automatically identify equivalent code for transpilation of each node of the AST data structure between the initial programmatic language and the target programmatic language; and
generating the output source code in the target programmatic language;
wherein upon identifying a plurality of available transpilation options in the transpiler library during the identification of equivalent code, the trained machine learning data model is configured to generate output logits corresponding to each available transpilation option, the available transpilation option of the with a highest output logit being selected as the equivalent code for generation of the output source code in the target programmatic language.

12. The method of claim 11, wherein the output source code in the target programmatic language is coupled with telemetry metadata representative of the plurality of available transpilation options and the selected available transpilation option used for the selection of the equivalent code; and wherein the trained machine learning data model architecture is retrained using a combination of performance data and the telemetry metadata representative of the plurality of available transpilation options.

13. The method of claim 12, wherein the performance data includes data sets extracted from daemon processes monitoring processing errors associated with downstream execution of the output source code.

14. The method of claim 12, wherein the performance data includes data sets extracted from daemon processes monitoring processing speed associated with downstream execution of the output source code.

15. The method of claim 12, wherein the performance data includes data sets extracted from daemon processes monitoring a weighted average of processing speed and processing errors associated with downstream execution of the output source code, the weighted average representing an objective function being minimized during retraining of the trained machine learning data model architecture.

16. The method of claim 15, wherein the retraining of the trained machine learning data model architecture is conducted in real or near-real time as errors or processing speed issues are identified during the downstream execution of the output source code, causing the trained machine learning data model architecture to be trained in accordance with a real-time feedback loop.

17. The method of claim 12, wherein the performance data includes data sets extracted from daemon processes monitoring processor load associated with downstream execution of the output source code.

18. The method of claim 12, wherein the performance data includes data sets extracted from daemon processes monitoring memory usage associated with downstream execution of the output source code.

19. The method of claim 12, wherein during a pre-training duration after instantiation of an untrained machine learning data model architecture, the downstream execution is conducted on a non-production environment simulating real-world usage and the untrained machine learning data model architecture is first trained during execution in the non-production environment to establish the trained machine learning data model architecture for usage in a production environment.

20. A non-transitory computer readable medium storing computer interpretable instruction sets, which when executed by a processor, cause the processor to perform a method for automated transpilation of query source code by transforming an initial source code provided in an initial programmatic language into an output source code provided in a target programmatic language to a distributed data processing or query system, the method comprising:
decomposing the initial source code to generate a syntax tree (AST) data structure, the AST data structure representing programmatic constructs within the initial source code as nodes of a plurality of nodes of the AST data structure;
maintaining a trained machine learning data model architecture, coupled to a transpiler library, trained for controlling transpilation between the initial programmatic language and the target programmatic language;
processing the AST data structure using the trained machine learning data model architecture to automatically identify equivalent code for transpilation of each node of the AST data structure between the initial programmatic language and the target programmatic language; and
generating the output source code in the target programmatic language;
wherein upon identifying a plurality of available transpilation options in the transpiler library during the identification of equivalent code, the trained machine learning data model is configured to generate output logits corresponding to each available transpilation option, the available transpilation option of the with a highest output logit being selected as the equivalent code for generation of the output source code in the target programmatic language.
